(19) United States
(12) Patent Application Publication
(10) Pub. No.: US 2025/0380277 A1
(43) Pub. Date: Dec. 11, 2025

(54) TECHNIQUES FOR INDICATING FEEDBACK WITH UNEQUAL QUANTITIES OF BITS PER DOWNLINK ASSIGNMENT INDEX

(71) Applicant: QUALCOMM Incorporated, San Diego, CA (US)

(72) Inventors: Mostafa KHOSHNEVISAN, San Diego, CA (US); Jing SUN, San Diego, CA (US); Junyi LI, Greentown, PA (US)

(21) Appl. No.: 18/736,355

(22) Filed: Jun. 6, 2024

(51) Int. Cl. H04W 72/232

(52) U.S. Cl. CPC H04W 72/232

(57) ABSTRACT

Methods, systems, and devices for wireless communications are described. A user equipment (UE) may monitor for multiple control messages, including a first control message, that each schedule one or more downlink messages, where a difference between a first value of a counter field in the first control message and a second value of the counter field of a previous control message of the multiple control messages may be based on whether the first control message is associated with a first type of control message or a second type of control message. Additionally, the UE may transmit a feedback message including at least a quantity of bits for indicating feedback for one or more first downlink messages associated with the first control message, where the quantity is based on whether the first control information message is associated with the first type of control message or the second type of control message.

### FIELD OF TECHNOLOGY

The following relates to wireless communications, including techniques for indicating feedback with unequal quantities of bits per downlink assignment index (DAI).

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a UE is described. The method may include monitoring for a set of multiple control information messages that each schedule one or more downlink messages, the set of multiple control information messages including at least a first control information message, where a first value of a counter field of the first control information message is incremented from a second value of the counter field of a previous control information message of the set of multiple control information messages, and where a difference between the first value and the second value is based on whether the first control information message is associated with a first type of control information message or a second type of control information message and transmitting a feedback message indicating feedback associated with the set of multiple control information messages, where a quantity of bits used to indicate the feedback associated with the first control information message is based on whether the first control information message is associated with the first type of control information message or the second type of control information message.

A UE for wireless communications is described. The UE may include one or more memories storing processor executable code, and one or more processors coupled with the one or more memories. The one or more processors may individually or collectively be operable to execute the code to cause the UE to monitor for a set of multiple control information messages that each schedule one or more downlink messages, the set of multiple control information messages including at least a first control information message, where a first value of a counter field of the first control information message is incremented from a second value of the counter field of a previous control information message of the set of multiple control information messages, and where a difference between the first value and the second value is based on whether the first control information message is associated with a first type of control information message or a second type of control information message and transmit a feedback message indicating feedback associated with the set of multiple control information messages, where a quantity of bits used to indicate the feedback associated with the first control information message is based on whether the first control information message is associated with the first type of control information message or the second type of control information message.

Another UE for wireless communications is described. The UE may include means for monitoring for a set of multiple control information messages that each schedule one or more downlink messages, the set of multiple control information messages including at least a first control information message, where a first value of a counter field of the first control information message is incremented from a second value of the counter field of a previous control information message of the set of multiple control information messages, and where a difference between the first value and the second value is based on whether the first control information message is associated with a first type of control information message or a second type of control information message and means for transmitting a feedback message indicating feedback associated with the set of multiple control information messages, where a quantity of bits used to indicate the feedback associated with the first control information message is based on whether the first control information message is associated with the first type of control information message or the second type of control information message.

A non-transitory computer-readable medium storing code for wireless communications is described. The code may include instructions executable by one or more processors to monitor for a set of multiple control information messages that each schedule one or more downlink messages, the set of multiple control information messages including at least a first control information message, where a first value of a counter field of the first control information message is incremented from a second value of the counter field of a previous control information message of the set of multiple control information messages, and where a difference between the first value and the second value is based on whether the first control information message is associated with a first type of control information message or a second type of control information message and transmit a feedback message indicating feedback associated with the set of multiple control information messages, where a quantity of bits used to indicate the feedback associated with the first control information message is based on whether the first control information message is associated with the first type of control information message or the second type of control information message.

In some examples of the method, UEs, and non-transitory computer-readable medium described herein, the first type of control information message may be associated with the quantity of bits being associated with a first value and the second type of control information message may be associated with the quantity of bits being associated with a second value different than the first value.

Some examples of the method, UEs, and non-transitory computer-readable medium described herein may further include operations, features, means, or instructions for receiving a configuration message indicating a configuration associated with a set of multiple types of control information messages, including at least the first type of control information message and the second type of control information message.

Some examples of the method, UEs, and non-transitory computer-readable medium described herein may further include operations, features, means, or instructions for transmitting a capability message indicating a capability to support a set of multiple types of control information messages including at least the first type of control information message and the second type of control information message, where monitoring for the set of multiple control information messages may be based on the capability.

In some examples of the method, UEs, and non-transitory computer-readable medium described herein, the first control information message may be associated with the first type of control information message based on the first control information message scheduling a set of multiple first downlink messages and both the difference between the first value and the second value and the quantity of bits used to indicate the feedback for the set of multiple first downlink messages may be equal to a quantity of the set of multiple first downlink messages based on the first control information message being associated with the first type of control information message.

In some examples of the method, UEs, and non-transitory computer-readable medium described herein, a first bit value for a bit of the quantity of bits indicates that a respective first downlink message of the set of multiple first downlink messages was decoded and a second bit value for the bit of the quantity of bits indicates that the respective first downlink message of the set of multiple first downlink messages was not decoded.

In some examples of the method, UEs, and non-transitory computer-readable medium described herein, the first control information message may be associated with the first type of control information message based on the first control information message indicating a reserved MCS, the first control information message schedules a first downlink message, and both the difference between the first value and the second value and the quantity of bits used to indicate the feedback associated with the first control information message may be equal to two based on the first control information message being associated with the first type of control information message and scheduling the first downlink message.

In some examples of the method, UEs, and non-transitory computer-readable medium described herein, the quantity of bits used to indicate the feedback associated with the first control information message jointly indicates whether the UE determined a TB size associated with the first downlink message and whether the first downlink message was decoded.

In some examples of the method, UEs, and non-transitory computer-readable medium described herein, a first value of the quantity of bits indicates that the UE decoded the first control information message, decoded the first downlink message, and determined the TB size, a second value of the quantity of bits indicates that the UE decoded the first control information message, failed to decode the first downlink message, and determined the TB size, and a third value of the quantity of bits indicates the UE decoded the first control information message, failed to decode the first downlink message, and failed to determine the TB size.

In some examples of the method, UEs, and non-transitory computer-readable medium described herein, a fourth value of the quantity of bits indicates the UE failed to decode the first control information message, failed to decode the first downlink message, and failed to determine the TB size.

In some examples of the method, UEs, and non-transitory computer-readable medium described herein, the first control information message may be associated with the first type of control information message based on the first control information message indicating a state change, the first control information message schedules a first downlink message, and both the difference between the first value and the second value and the quantity of bits used to indicate the feedback associated with the first control information message may be equal to 2 based on the first control information message being associated with the first type of control information message and scheduling the first downlink message.

In some examples of the method, UEs, and non-transitory computer-readable medium described herein, a first bit used to indicate the feedback associated with the first control information message indicates whether the UE performed the state change and a second bit used to indicate the feedback associated with the first control information message indicates whether the first downlink message was decoded.

In some examples of the method, UEs, and non-transitory computer-readable medium described herein, a first bit value for the first bit indicates that the state change was performed, and a second bit value for the first bit indicates that the state change was not performed.

In some examples of the method, UEs, and non-transitory computer-readable medium described herein, the state change may be associated with a TCI state change, a BWP change, an SSS group switch, a downlink control channel monitoring skip, a cell dormancy, a scheduling offset change, or any combination thereof.

In some examples of the method, UEs, and non-transitory computer-readable medium described herein, the first control information message schedules a first downlink message and the first control information message includes a field indicating whether the first control information message may be associated with the first type of control information message or the second type of control information message.

In some examples of the method, UEs, and non-transitory computer-readable medium described herein, the first type of control information may be associated with a set of multiple bits being used to indicate the feedback associated with the first control information message, a first bit of the set of multiple bits indicates whether the first control information message was decoded, and a second bit of the set of multiple bits indicates whether the first downlink message was decoded.

In some examples of the method, UEs, and non-transitory computer-readable medium described herein, the first control information message may be associated with the first type of control information message based on the first control information message excluding a field indicating whether the first control information message may be associated with the first type of control information message or the second type of control information message.

A method for wireless communications by a network entity is described. The method may include transmitting a set of multiple control information messages that each schedule one or more downlink messages, the set of multiple control information messages including at least a first control information message, where a first value of a counter field of the first control information message is incremented from a second value of the counter field of a previous control information message of the set of multiple control information messages, and where a difference between the first value and the second value is based on whether the first control information message is associated with a first type of control information message or a second type of control information message and receiving a feedback message indicating feedback associated with the set of multiple control information messages, where a quantity of bits used to indicate the feedback associated with the first control information message is based on whether the first control information message is associated with the first type of control information message or the second type of control information message.

A network entity for wireless communications is described. The network entity may include one or more memories storing processor executable code, and one or more processors coupled with the one or more memories. The one or more processors may individually or collectively be operable to execute the code to cause the network entity to transmit a set of multiple control information messages that each schedule one or more downlink messages, the set of multiple control information messages including at least a first control information message, where a first value of a counter field of the first control information message is incremented from a second value of the counter field of a previous control information message of the set of multiple control information messages, and where a difference between the first value and the second value is based on whether the first control information message is associated with a first type of control information message or a second type of control information message and receive a feedback message indicating feedback associated with the set of multiple control information messages, where a quantity of bits used to indicate the feedback associated with the first control information message is based on whether the first control information message is associated with the first type of control information message or the second type of control information message.

Another network entity for wireless communications is described. The network entity may include means for transmitting a set of multiple control information messages that each schedule one or more downlink messages, the set of multiple control information messages including at least a first control information message, where a first value of a counter field of the first control information message is incremented from a second value of the counter field of a previous control information message of the set of multiple control information messages, and where a difference between the first value and the second value is based on whether the first control information message is associated with a first type of control information message or a second type of control information message and means for receiving a feedback message indicating feedback associated with the set of multiple control information messages, where a quantity of bits used to indicate the feedback associated with the first control information message is based on whether the first control information message is associated with the first type of control information message or the second type of control information message.

A non-transitory computer-readable medium storing code for wireless communications is described. The code may include instructions executable by one or more processors to transmit a set of multiple control information messages that each schedule one or more downlink messages, the set of multiple control information messages including at least a first control information message, where a first value of a counter field of the first control information message is incremented from a second value of the counter field of a previous control information message of the set of multiple control information messages, and where a difference between the first value and the second value is based on whether the first control information message is associated with a first type of control information message or a second type of control information message and receive a feedback message indicating feedback associated with the set of multiple control information messages, where a quantity of bits used to indicate the feedback associated with the first control information message is based on whether the first control information message is associated with the first type of control information message or the second type of control information message.

In some examples of the method, network entities, and non-transitory computer-readable medium described herein, the first type of control information message may be associated with both the difference between the first value and the second value and the quantity of bits being associated with a first value and the second type of control information message may be associated with both the difference between the first value and the second value and the quantity of bits being associated with a second value different than the first value.

Some examples of the method, network entities, and non-transitory computer-readable medium described herein may further include operations, features, means, or instructions for transmitting a configuration message indicating a configuration associated with a set of multiple types of control information messages, including at least the first type of control information message and the second type of control information message.

Some examples of the method, network entities, and non-transitory computer-readable medium described herein may further include operations, features, means, or instructions for receiving a capability message indicating a capability of a UE to support a set of multiple types of control information messages, including at least the first type of control information message and the second type of control information message, where transmitting the set of multiple control information messages may be based on the capability of the UE.

In some examples of the method, network entities, and non-transitory computer-readable medium described herein, the first control information message may be associated with the first type of control information message based on the first control information message scheduling a set of multiple first downlink messages and both the difference between the first value and the second value and the quantity of bits used to indicate the feedback for the set of multiple first downlink messages may be equal to a quantity of the set of multiple first downlink messages based on the first control information message being associated with the first type of control information message.

In some examples of the method, network entities, and non-transitory computer-readable medium described herein, the first control information message may be associated with the first type of control information message based on the first control information message indicating a reserved MCS, the first control information message schedules a first downlink message, and both the difference between the first value and the second value and the quantity of bits used to indicate the feedback associated with the first control information message may be equal to two based on the first control information message being associated with the first type of control information message and scheduling the first downlink message.

In some examples of the method, network entities, and non-transitory computer-readable medium described herein, the quantity of bits used to indicate the feedback associated with the first control information message jointly indicate whether a UE determined a TB size associated with the first downlink message and whether the first downlink message was decoded.

In some examples of the method, network entities, and non-transitory computer-readable medium described herein, the first control information message may be associated with the first type of control information message based on the first control information message indicating a state change, the first control information message schedules a first downlink message, and both the difference between the first value and the second value and the quantity of bits used to indicate the feedback associated with the first control information message may be equal to 2 based on the first control information message being associated with the first type of control information message and scheduling the first downlink message.

In some examples of the method, network entities, and non-transitory computer-readable medium described herein, the first control information message schedules a first downlink message and the first control information message includes a field indicating whether the first control information message may be associated with the first type of control information message or the second type of control information message.

In some examples of the method, network entities, and non-transitory computer-readable medium described herein, the first type of control information may be associated with a set of multiple bits being used to indicate the feedback associated with the first control information message, a first bit of the set of multiple bits indicates whether the first control information message was decoded, and a second bit of the set of multiple bits indicate whether the first downlink message was decoded.

In some examples of the method, network entities, and non-transitory computer-readable medium described herein, the first control information message may be associated with the first type of control information message based on the first control information message excluding a field indicating whether the first control information message may be associated with the first type of control information message or the second type of control information message.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports techniques for indicating feedback with unequal quantities of bits per downlink assignment index (DAI) in accordance with one or more aspects of the present disclosure.

FIG. 2 shows an example of a wireless communications system that supports techniques for indicating feedback with unequal quantities of bits per DAI in accordance with one or more aspects of the present disclosure.

FIG. 3 shows an example of a timing diagram that supports techniques for indicating feedback with unequal quantities of bits per DAI in accordance with one or more aspects of the present disclosure.

FIG. 4 shows an example of a timing diagram that supports techniques for indicating feedback with unequal quantities of bits per DAI in accordance with one or more aspects of the present disclosure.

FIG. 5 shows an example of a timing diagram that supports techniques for indicating feedback with unequal quantities of bits per DAI in accordance with one or more aspects of the present disclosure.

FIG. 6 shows an example of a process flow that supports techniques for indicating feedback with unequal quantities of bits per DAI in accordance with one or more aspects of the present disclosure.

FIGS. 7 and 8 show block diagrams of devices that support techniques for indicating feedback with unequal quantities of bits per DAI in accordance with one or more aspects of the present disclosure.

FIG. 9 shows a block diagram of a communications manager that supports techniques for indicating feedback with unequal quantities of bits per DAI in accordance with one or more aspects of the present disclosure.

FIG. 10 shows a diagram of a system including a device that supports techniques for indicating feedback with unequal quantities of bits per DAI in accordance with one or more aspects of the present disclosure.

FIGS. 11 and 12 show block diagrams of devices that support techniques for indicating feedback with unequal quantities of bits per DAI in accordance with one or more aspects of the present disclosure.

FIG. 13 shows a block diagram of a communications manager that supports techniques for indicating feedback with unequal quantities of bits per DAI in accordance with one or more aspects of the present disclosure.

FIG. 14 shows a diagram of a system including a device that supports techniques for indicating feedback with unequal quantities of bits per DAI in accordance with one or more aspects of the present disclosure.

FIGS. 15 and 16 show flowcharts illustrating methods that support techniques for indicating feedback with unequal quantities of bits per DAI in accordance with one or more aspects of the present disclosure.

### DETAILED DESCRIPTION

In some wireless communications systems, user equipments (UEs) may support transmission of feedback (e.g., hybrid automatic repeat request (HARQ) feedback) for multiple downlink messages, such as physical downlink control channels (PDSCHs), scheduled by multiple control messages (e.g., downlink control information (DCI)). In such cases, each DCI may include a counter downlink assignment index (cDAI) field indicating a cumulative quantity of serving cell-PDSCH monitoring occasion pairs in which DCIs have been sent by a network entity, up to a current serving cell and a current PDSCH monitoring occasion. Additionally, in some cases, such as for carrier aggregation, each DCI may include a total DAI (tDAI) field indicating a total quantity of serving cell-PDSCH monitoring occasion pairs in which DCIs have been sent by a network entity, up to a current PDSCH monitoring occasion, across all carriers associated with the carrier aggregation. A UE may transmit a feedback message indicating feedback for the multiple PDSCHs, where a position of a feedback indication (e.g., one or more bits) for a given downlink control message in the feedback message (e.g., including a codebook) may correspond to a position of an associated DCI (e.g., a DCI scheduling the given downlink control message) within the multiple DCIs based on a corresponding cDAI. In other words, the UE may order feedback for the multiple PDSCHs (e.g., in the feedback message) in a same order as the multiple DCIs, where the order of the multiple DCIs is based on corresponding cDAI values. For a given DCI, the UE may transmit an acknowledgment (ACK) or negative ACK (NACK) in the feedback message based on whether or not the UE successfully decoded an associated PDSCH and, if the UE does not receive the DCI, the UE may transmit a NACK in the feedback message.

In some cases, however, different quantities of bits may be associated with providing feedback associated with different DCIs. For example, a DCI may schedule multiple PDSCHs rather than a single PDSCH, such that the UE may transmit multiple bits to indicate feedback for the multiple PDSCHs rather than a single bit to indicate feedback for the single PDSCH. In some cases, to support the different quantities of bits, the UE may transmit separate sub-codebooks with separate DAI counting processes. However, if a last DCI from either sub-codebook is missed by the UE (e.g., is not received by the UE), a size mismatch may exist between a first size of a codebook (e.g., including the separate sub-codebooks) transmitted by the UE and a second size of the codebook expected by the network entity. Additionally, transmitting separate sub-codebooks may result in increased overhead. In some other cases, to support the different quantities of bits, the UE may transmit a same quantity of bits per DAI (e.g., associated with each DCI), where the quantity of bits may satisfy a threshold (e.g., maximum) quantity of bits out of the different quantities of bits. However, using the threshold quantity of bits for feedback associated with each DCI may result in unnecessary increases in overhead, particularly when a majority (e.g., more than 50 percent) of the multiple DCIs are capable of supporting a relatively smaller quantity of bits for associated feedback (e.g., do not need the threshold quantity of bits for reporting feedback for associated PDSCHs).

Techniques described herein may enable a UE to transmit, via a single codebook, feedback, for multiple PDSCHs scheduled by multiple DCIs, using variable quantities of bits based on DAI values of the multiple DCIs being incremented by different quantities based on a respective type of each DCI. For example, the UE (e.g., and a network entity) may support multiple types of DCIs, including a first type of DCI, which may be referred to as a normal DCI, and one or more second types of DCIs, which may be referred to as one or more special DCIs, or some other terminology. In such cases, a value of a DAI field, which may be referred to as a DAI value, in a normal DCI may be incremented (e.g., by the network entity) by 1 relative to a DAI value of a previous DCI, while a DAI value in a special DCI may be incremented by a first quantity greater than 1 relative to a DAI value of a previous DCI. In such cases, the quantity may be different for different special DCIs. Thus, the UE may transmit, in a codebook, a single bit indicating feedback associated with a DAI value detected from a normal DCI (e.g., for a PDSCH scheduled by the normal DCI) and may transmit, in the codebook, the first quantity of bits indicating feedback associated with a DAI value detected from a special DCI (e.g., for one or more PDSCHs scheduled by the special DCI).

In some cases, a first special DCI of the one or more special DCIs may be a DCI that schedules a PDSCH with multiple transport blocks (TBs), where the first quantity is based on a quantity of the multiple TBs. Additionally, or alternatively, a second special DCI of the one or more special DCIs may be a DCI that indicates a reserved modulation and coding scheme (MCS), such that the first quantity of bits may include a first bit for indicating whether a TB size is known by the UE and a second quantity of bits based on a quantity of TBs scheduled by the second special DCI. Additionally, or alternatively, a third special DCI of the one or more special DCIs may be a DCI that indicates a new state for the UE, such that the first quantity of bits may include a first bit for indicating whether the new state was applied by the UE and a third quantity of bits based on a quantity of TBs scheduled by the third special DCI.

Aspects of the disclosure are initially described in the context of wireless communications systems. Aspects of the disclosure are then described in the context of timing diagrams and a process flow. Aspects of the disclosure are further illustrated by and described herein with reference to apparatus diagrams, system diagrams, and flowcharts that relate to techniques for indicating feedback with unequal quantities of bits per DAI.

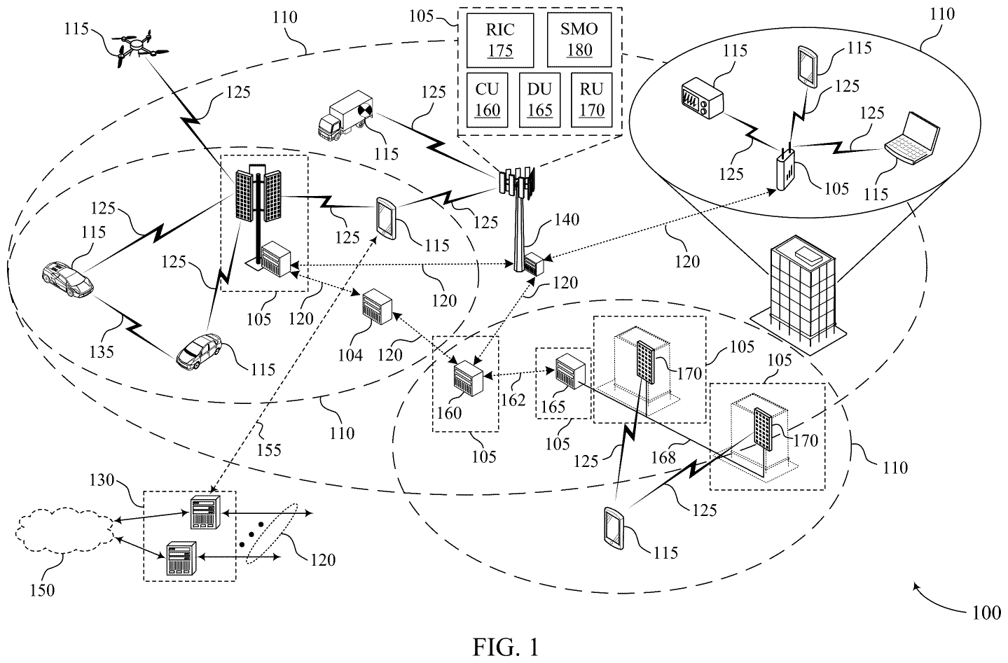

FIG. 1 shows an example of a wireless communications system 100 that supports techniques for indicating feedback with unequal quantities of bits per DAI in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The UEs 115 and the network entities 105 may support retransmissions of data to increase the likelihood that data is received successfully. HARQ feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

The wireless communications system 100 may support techniques that enable a UE 115 to transmit, via a single codebook, feedback for multiple PDSCHs scheduled by multiple DCIs using variable quantities of bits based on corresponding DAI values of the multiple DCIs being incremented by different quantities, which are based on a respective type of each DCI. For example, the UE 115 (e.g., and a network entity 105) may support multiple types of DCIs, including a first type of DCI, which may be referred to as a normal DCI, and one or more second types of DCIs, which may be referred to as one or more special DCIs (e.g., indicating one or more DCIs that have a defined purpose, function, parameters, attributes, and/or other features that may be different from other DCIs). In such cases, a value of a DAI field, which may be referred to as a DAI value, in a normal DCI may be incremented (e.g., by the network entity 105) by 1 relative to a DAI value of a previous DCI, while a DAI value in a special DCI may be incremented by a first quantity greater than 1 relative to a DAI value of a previous DCI. In such cases, the quantity may be different for respective special DCIs. Thus, the UE 115 may transmit, in a codebook, a single bit indicating feedback associated with a DAI value detected from a normal DCI (e.g., for a PDSCH scheduled by the normal DCI) and may transmit, in the codebook, the first quantity of bits indicating feedback associated with a DAI value detected from a special DCI (e.g., for one or more PDSCHs scheduled by the special DCI).

In some cases, a first special DCI of the one or more special DCIs may be a DCI that schedules a PDSCH with multiple TBs, where the first quantity is based on a quantity of the multiple TBs. Additionally, or alternatively, a second special DCI of the one or more special DCIs may be a DCI that indicates a reserved MCS, such that the first quantity of bits may include a first bit for indicating whether a TB size is known by the UE 115 and a second quantity of bits based on a quantity of TBs scheduled by the second special DCI. Additionally, or alternatively, a third special DCI of the one or more special DCIs may be a DCI that indicates a new state for the UE 115, such that the first quantity of bits may include a first bit for indicating whether the new state was applied by the UE 115 and a third quantity of bits based on a quantity of TBs scheduled by the third special DCI.

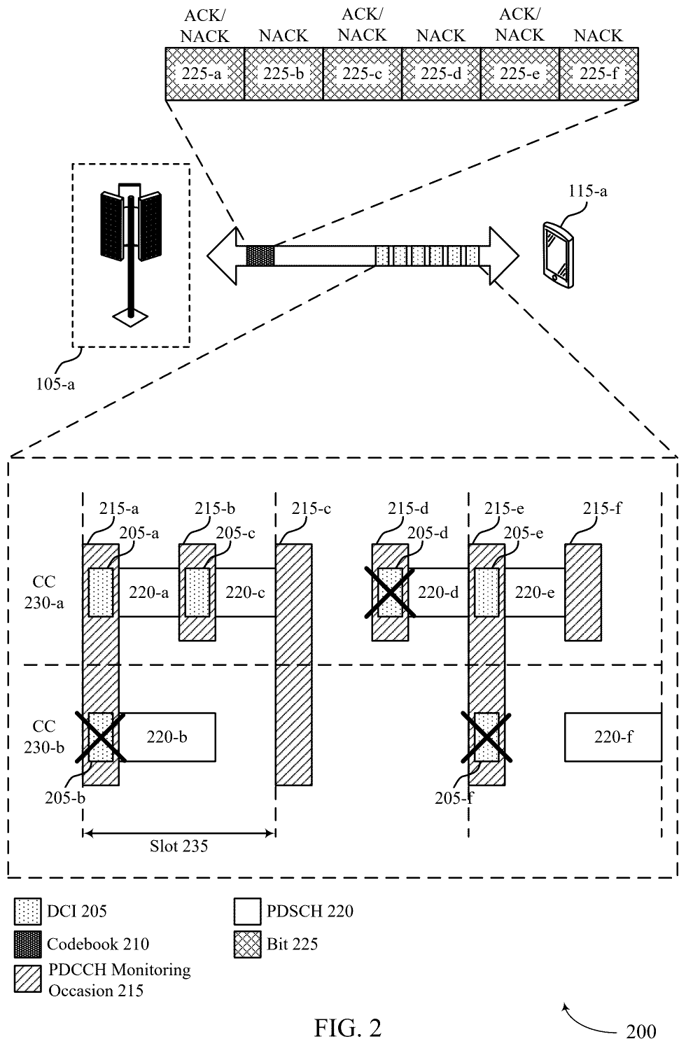

FIG. 2 shows an example of a wireless communications system 200 that supports techniques for indicating feedback with unequal quantities of bits per DAI in accordance with one or more aspects of the present disclosure. In some cases, the wireless communications system 200 may implement or be implemented by aspects of the wireless communications system 100. For example, the wireless communications system 200 may include one or more UEs 115 (e.g., a UE 115-a) and one or more network entities 105 (e.g., a network entity 105-a), which may be examples of the corresponding devices as described herein.

In some wireless communications systems, such as the wireless communications system 200, wireless devices, such as the UE 115-a, may support transmission of feedback, such as HARQ feedback. The feedback may be for multiple downlink messages, such as PDSCHs 220, that are scheduled by multiple control messages, such as DCIs 205. For example, the UE 115-a may monitor for one or more DCIs 205 via one or more physical downlink control channel (PDCCH) monitoring occasions 215. In such cases, the one or more PDCCH monitoring occasions 215 may be based on configuration (e.g., by the network entity 105-a) of different search space (SS) sets in different serving cells. In some cases, the UE 115-a may include PDCCH monitoring occasions 215 across active downlink BWPs of the different serving cells in a same group, where the one or more PDCCH monitoring occasions 215 may be ordered (e.g., in the group) in ascending order of start time of a SS set associated with a PDCCH monitoring occasions 215. For example, a first PDCCH monitoring occasion 215 may be associated with a first SS set further associated with a first start time and a second PDCCH monitoring occasion 215 may be associated with a second SS set further associated with a second start time after the first start time, such that the first PDCCH monitoring occasion 215 is ordered before the second PDCCH monitoring occasion 215. Additionally, or alternatively, if two SS sets (e.g., of the same or different serving cells) are associated with a same start time, PDCCH monitoring occasions 215 associated with the two SS sets may be counted (e.g., considered) as one PDCCH monitoring occasion 215.

Additionally, each DCI 205 may indicate one or more DAIs (e.g., values of one or more DAI fields). For example, each DCI 205 may indicate a cDAI (e.g., via a cDAI field in the DCI 205) indicating a cumulative quantity of serving cell-PDCCH monitoring occasion 215 pairs in which DCIs 205 have been sent by the network entity 105-a, up to a current serving cell and a current PDCCH monitoring occasion 215 (e.g., serving cell first, PDCCH monitoring occasion 215 second). Additionally, or alternatively, in some cases, such as for carrier aggregation (e.g., multiple serving cells), each DCI 205 may indicate a tDAI (e.g., via a tDAI field in the DCI 205) indicating a total quantity of serving cell-PDCCH monitoring occasion 215 pairs in which DCIs 205 have been sent by the network entity 105-a, up to a current PDCCH monitoring occasion 215 (e.g., without carrier aggregation the tDAI field may not exist). In such cases, the network entity 105-a may indicate a same tDAI value in all DCIs 205 in a same PDCCH monitoring occasion 215 to protect against missing a DCI 205 corresponding to a last serving cell in the same PDCCH monitoring occasion 215. In either case, a DCI 205 may use 2 bits to indicate a cDAI and 2 bits to indicate a tDAI (e.g., 2 bits in each of the cDAI field and the tDAI field, a modulo 4 operation).

In some cases, each DCI 205 may schedule a PDSCH 220 and the UE 115-a may transmit a codebook 210 (e.g., via a feedback message) indicating feedback for the PDSCHs 220 scheduled by the DCIs 205. In such cases, a position of feedback for a given PDSCH 220 in the codebook 210 (e.g., a HARQ-ACK codebook) may correspond to a position of an associated DCI 205 (e.g., that schedules the given PDSCH 220) within the multiple DCIs 205 based on a corresponding cDAI value. For example, a first DCI 205 may include a cDAI value of 1 and may schedule a first PDSCH 220 and a second DCI 205 may include a cDAI value of 2 and may schedule a second PDSCH 220, such that feedback for the first PDSCH 220 may be first and feedback for the second PDSCH 220 may be second (e.g., within the codebook 210). In other words, the UE 115-a may order feedback for the multiple PDSCHs 220 (e.g., in the codebook 210, in the codebook) in a same order as the multiple DCIs 205, where the order of the multiple DCIs 205 is based on corresponding cDAI values.

In such cases, if a DCI 205 is not missed (e.g., is received by the UE 115-a), the UE 115-a may indicate (e.g., place) an ACK or NACK corresponding to a PDSCH 220, scheduled by the DCI 205, in the codebook 210 in a same order as a cDAI indicated by the DCI 205 (e.g., in a position corresponding to the cDAI indicated by the DCI 205). For example, the UE 115-a may receive a DCI 205-a with a cDAI of 1 and may receive and decode a PDSCH 220-a scheduled by the DCI 205-a, such that the UE 115-a may indicate an ACK via a bit 225-a in the codebook 210 based on decoding the PDSCH 220-a, where the bit 225-a corresponds to the cDAI of 1. Conversely, if a DCI 205 is missed (e.g., is not receive by the UE 115-a, is not decoded by the UE 115-a), the UE 115-a may indicate (e.g., place) a NACK in the codebook 210 in a same order as the cDAI indicated by the DCI 205 (e.g., in the position corresponding to the cDAI indicated by the DCI 205). For example, the UE 115-a may fail to receive or fail to decode a DCI 205-b with a cDAI of 2, such that the UE 115-a may indicate a NACK via a bit 225-b in the codebook 210 based on failing to receive or failing to decode the DCI 205-b.

In some cases, the UE 115-a may determine (e.g., identify) that a DCI 205 was missed by comparing consecutive cDAI values. For example, the UE 115-a may receive the DCI 205-a indicating the cDAI of 1 and may receive a DCI 205-c indicating a cDAI of 3, such that the UE 115-a may determine that the DCI 205-b indicating the cDAI of 2 was missed. Additionally, or alternatively, the UE 115-a may determine that a DCI 205 was missed by comparing tDAI with cDAI of all DCIs 205 in a same PDCCH monitoring occasion 215. For example, for two serving cells in a PDCCH monitoring occasion 215-a, the UE 115-a may receive (e.g., only receive) the DCI 205-a with (cDAI, tDAI)=(1,2), such that the UE 115-a may identify that the DCI 205-b (e.g., a second DCI 205) with (cDAI, tDAI)=(2,2) was not received.

As an illustrative example, as depicted in FIG. 2, the UE 115-a may support (e.g., be configured with) a CC 230-a (e.g., CC0) and a CC 230-b (e.g., CC1), where the CC 230-a is associated with two PDCCH monitoring occasions 215 per slot 235 and the CC 230-b is associated with one PDCCH monitoring occasion 215 per slot 235. In some cases, the network entity 105-a may transmit, during a PDCCH monitoring occasion 215-a, a DCI 205-a via the CC 230-a and a DCI 205-b via the CC 230-b. In such cases, the DCI 205-a may indicate (cDAI, tDAI)=(1,2) and may schedule a PDSCH 220-a and the DCI 205-b may indicate (cDAI, tDAI)=(2,2) and may schedule a PDSCH 220-b. However, the UE 115-a may receive and decode the DCI 205-a but may not receive or may not decode (e.g., may miss) the DCI 205-b. In some cases, the UE 115-a may identify that the UE 115-a missed the DCI 205-b based on the DCI 205-a indicating the tDAI=2 but the UE 115-a receiving (e.g., only receiving) one DCI 205 during PDCCH monitoring occasion 215-a.

Additionally, the network entity 105-a may transmit, during a PDCCH monitoring occasion 215-b, a DCI 205-c via the CC 230-a, where the DCI 205-c may indicate (cDAI, tDAI)=(3,3) and may schedule a PDSCH 220-c. In such cases, the UE 115-a may receive and decode the DCI 205-c and, in some cases, may identify that the UE 115-a missed (e.g., failed to receive or decode) the DCI 205-b based on identifying that the DCI 205-a included the cDAI=1 and the DCI 205-c included the cDAI=3. That is, the UE 115-a may identify that the cDAI=2 was missed based on identifying that the DCI 205-c included the cDAI=1 and the DCI 205-c included the cDAI=3.

The network entity 105-a may not transmit a DCI 205 during the PDCCH monitoring occasion 215-c but may transmit, during the PDCCH monitoring occasion 215-d, a DCI 205-d, where the DCI 205-d may indicate (cDAI, tDAI)=(4,4) and may schedule a PDSCH 220-d. However, the UE 115-a may not receive or may not decode the DCI 205-d. Additionally, the network entity 105-a may transmit, during the PDCCH monitoring occasion 215-c, a DCI 205-e and a DCI 205-f. In such cases, the DCI 205-c may indicate (cDAI, DAI)=(1,2) and may schedule a PDSCH 220-c and the DCI 205-f may indicate (cDAI, tDAI)=(2,2) and may schedule a PDSCH 220-f. However, the UE 115-a may receive and decode the DCI 205-e but may not receive or may not decode (e.g., may miss) the DCI 205-f.

In some cases, the UE 115-a may identify that the UE 115-a missed the DCI 205-d based on identifying that the DCI 205-c included the cDAI=3 and the DCI 205-e included the cDAI=1. That is, the UE 115-a may identify that the cDAI=4 was missed based on identifying that the DCI 205-c included the cDAI=3 and the DCI 205-e included the cDAI=1. As described herein, the cDAI field may be associated with 2 bits, where ‘00’ in the cDAI field may indicate cDAI=1, ‘01’ in the cDAI field may indicate cDAI=2, ‘10’ in the cDAI field may indicate cDAI=3, and ‘11’ in the cDAI field may indicate cDAI=4. As such, to continue counting after cDAI=4, the cDAI field may return to cDAI=1. Thus, the cDAI=3 followed by the cDAI=1 may indicate that the cDAI=4 was missed.

Additionally, the UE 115-a may identify that the UE 115-a missed the DCI 205-f based on the DCI 205-e indicating the tDAI=2 but the UE 115-a receiving (e.g., only receiving) one DCI 205 during PDCCH monitoring occasion 215-c. The network entity 105-a may not transmit a DCI 205 during a PDCCH monitoring occasion 215-f.

Thus, the UE 115-a may transmit feedback associated with the DCIs 205 via a codebook 210 (e.g., codebook transmitted via PUCCH) after the PDCCH monitoring occasion 215-f. The codebook 210 may include a bit 225 corresponding to each cDAI value (e.g., each DCI 205). For example, a bit 225-a may be associated with feedback for the PDSCH 220-a scheduled by the DCI 205-a indicating (cDAI, tDAI)=(1,2), a bit 225-b may be associated with feedback for the PDSCH 220-b scheduled by the DCI 205-b indicating (cDAI, tDAI)=(2,2), a bit 225-c may be associated with feedback for the PDSCH 220-c scheduled by the DCI 205-c indicating (cDAI, tDAI)=(3,3), a bit 225-d may be associated with feedback for the PDSCH 220-d scheduled by the DCI 205-e indicating (cDAI, tDAI)=(4,4), a bit 225-e may be associated with feedback for the PDSCH 220-e scheduled by the DCI 205-e indicating (cDAI, tDAI)=(1,2), and a bit 225-f may be associated with feedback for the PDSCH 220-f scheduled by the DCI 205-f indicating (cDAI, tDAI)=(2,2).

However, as described herein, the UE 115-a may have missed the DCI 205-b, the DCI 205-d, and the DCI 205-f, such that the UE 115-a may indicate NACK via the bit 225-b, the bit 225-d, and the bit 225-f. Conversely, the UE 115-a may have received the DCI 205-a, the DCI 205-c, and the DCI 205-e, such that the UE 115-a may indicate an ACK or a NACK in each of the bit 225-a, the bit 225-c, and the bit 225-e based on whether the UE 115-a receive and decoded the PDSCH 220-a, the PDSCH 220-c, and the PDSCH 220-e, respectively. That is, the UE 115-a may indicate an ACK if a PDSCH 220 was received and decoded and may indicate a NACK if the PDSCH was not received or was not decoded.

In some cases (e.g., for Type 2 codebooks), as depicted in FIG. 2, each position in the codebook 210 corresponding to a DAI value may include a single bit 225 (e.g., ACK or NACK). However, in some other cases (e.g., in NR), different quantities of bits 225 may be used for providing feedback associated with different DCIs 205 (e.g., PDSCHs 220). For example, a DCI 205 may schedule multiple PDSCHs 220 rather than a single PDSCH 220, such that the UE 115-a may use multiple bits 225 to indicate feedback for the multiple PDSCHs 220 (e.g., associated with the DCI 205) rather than a single bit 225 to indicate feedback for a single PDSCH.

Thus, in some cases, to support the different quantities of bits 225 (e.g., and support robustness against missing DCIs 205 to avoid codebook size mismatch issues), the UE 115-a may transmit separate sub-codebooks (e.g., within a codebook 210) with separate (e.g., independent) DAI counting processes. For example, the UE 115-a may support a TB-based sub-codebook associated with 1 bit 225 per DAI (e.g., in the TB-based sub-codebook) and a codebook group (CBG)-based sub-codebook associated with a first quantity of bits 225 per DAI (e.g., in the CBG-based sub-codebook), where the first quantity of bits 225 is based on a threshold quantity of CBGs. Additionally, or alternatively, the UE 115-a may support a single-PDSCH scheduling sub-codebook associated with 1 bit 225 per DAI (e.g., in the single-PDSCH scheduling sub-codebook) and a multi-PDSCH scheduling sub-codebook associated with a second quantity of bits 225 per DAI (e.g., in the multi-PDSCH scheduling sub-codebook), where the second quantity of bits 225 is based on a threshold quantity of PDSCHs 220 (e.g., that can be scheduled using a single DCI 205). Additionally, or alternatively, the UE 115-a may support a single-CC scheduling sub-codebook associated with 1 bit 225 per DAI (e.g., in the single-CC scheduling sub-codebook) and a multi-CC scheduling sub-codebook associated with a third quantity of bits 225 per DAI (e.g., in the multi-CC scheduling sub-codebook), where the third quantity of bits 225 is based on a threshold quantity of CCs (e.g., that can be scheduled using a single DCI 205). However, in any case, if a last DCI 205 from either sub-codebook (e.g., of the separate sub-codebooks) is missed, a size mismatch may exist between a first size of a codebook 210 (e.g., including the separate sub-codebooks) transmitted by the UE 115-a and a second size of the codebook 210 expected by the network entity 105-a (e.g., a “last missing DCI 205 issue,” or size mismatch, may be worse than without sub-codebooks). Additionally, transmitting separate sub-codebooks may result in increased overhead. For example, transmitting separate sub-codebooks may result in additional overhead for uplink DCI as multiple uplink total DAIs may be needed in uplink DCI (e.g., to support PUSCH rate matching not being impacted when HARQ-ACK is multiplexed on PUSCH).

In some other cases, to support the different quantities of bits 225, the UE 115-a may transmit a same quantity of bits 225 per DAI (e.g., associated with each DCI 205) in a codebook 210, where the quantity of bits 225 may be a threshold (e.g., maximum) quantity of bits 225 out of the different quantities of bits 225. For example, a first DCI 205 may indicate a first DAI and may be associated with 1 bits 225 for feedback associated with the first DAI, a second DCI 205 may indicate a second DAI value and may be associated 2 bits 225 for feedback associated with the second DAI value, and a third DCI 205 may indicate a third DAI value and may be associated 3 bits 225 for feedback associated with the third DAI value, such that a codebook 210 indicating feedback associated with the first DCI 205, the second DCI 205, and the third DCI 205 may include 3 bits 225 per DAI. Thus, when a smaller quantity of bits 225 is associated with a given DAI, such as with the first DAI and the second DAI, the UE 115-a may perform zero-padding for the given DAI location (e.g., NACKs are inserted in the extra bits 225). In such cases, the DAI counting process may not be independent across different DCIs.

For example, if a threshold quantity of TBs per PDSCH 220 is configured as 2 for at least one CC 230, the UE 115-a may generate 2 bits 225 for each DAI location (e.g., each set of bits 225 corresponding to a DAI in the codebook 210), such that when a DCI 205 schedules a PDSCH 220 with a single TB (e.g., or codeword), a second bit 225 indicating feedback associated with the DCI 205 may be set to NACK (e.g., dummy NACK). In another example, for the CBG-based sub-codebook, the UE 115-a may support a threshold (e.g., maximum) quantity of CBGs across all CCs 230, such that the UE 115-a may generate a quantity of bits 225 for each DAI location, where the quantity of bits 225 is equal to the threshold quantity of CBGs. Thus, when a given PDSCH 220 includes a quantity of CBGs smaller than threshold quantity, NACKs may be inserted at an end of the DAI location correspond to the given PDSCH 220 (e.g., in the extra bits 225).

However, using the same quantity of bits 225 per DAI in a codebook 210, where the quantity of bits 225 may be a threshold quantity of bits 225, may result in unnecessary increases in overhead, particularly when a majority (e.g., more than 50 percent) of the multiple DCIs 205 are capable of supporting a smaller quantity of bits 225 for associated feedback (e.g., do not need the threshold quantity of bits 225 for reporting feedback for associated PDSCHs 220). In other words, a codebook 210 may include more dummy NACKs than feedback (e.g., a threshold quantity of NACKs).

Accordingly, techniques described herein may enable the UE 115-a to support a same DAI counting process across all DCIs 205 with different quantities of bits 225 (e.g., feedback bits) per DAI (e.g., associated with each DCI 205). In some aspects (e.g., for Type 2 HARQ-ACK codebook generation), the UE 115-a may assume that a DAI value in a DCI 205 may be incremented by one (e.g., by the network entity 105-a, from a previous DAI value in a previous DCI 205) for a first type of DCI 205, which may be referred to as a normal DCI, and may be incremented by more than one (e.g., by the network entity 105-a, from a previous DAI value in a previous DCI 205) for one or more second types of DCIs 205, which may be referred to as special DCIs 205. In such cases, the phrase normal vs special may simply be indicative of whether a DAI value is incremented by one or more than one (e.g., normal DCIs 205 may be all DCIs 205 that have associated HARQ-ACK feedback but are not special DCIs 205).

As such, the UE 115-a may generate (e.g., create) an ordered list of DAI values from detected DCIs 205, where the order is based on serving cell first, PDCCH monitoring occasion 215 second. The UE 115-a may place one bit 225 in a codebook 210 corresponding to a DAI value from a detected normal DCI 205, where the one bit indicates ACK or NACK. Conversely, the UE 115-a may place ‘X’ bits 225 in the codebook 210 corresponding to a DAI value from a detected special DCI 205, where the value of ‘X’ is based on a type of special DCI 205. Thus, when the UE 115-a detects a special DCI 205 with a given DAI value ‘V,’ the UE 115-a may compare a value of V−X+1 (e.g., or (V−X)mod (4)+1) with a DAI value of a latest previous DCI 205 (e.g., normal or special) and may detect a missed DCI 205 based on the comparison (e.g., based on missing a DAI value, based on a DAI hole). In such cases, the UE 115-a may indicate (e.g., place) a NACK in the codebook 10 corresponding to missing DAI values. In some cases, X−1 DAI values before a DAI value of a detected special DCI 205 may not be counted as missing DAI values. Additionally, if a special DCI 205 is missed, all ‘X’ missing DAI values may be counted as missing (e.g., as normal from the UE 115-a point of view). That is, for ‘X’ consecutive missing DAI values, the UE 115-a may be unaware as to whether the UE 115-a missed multiple normal DCIs 205 or one special DCI 205.

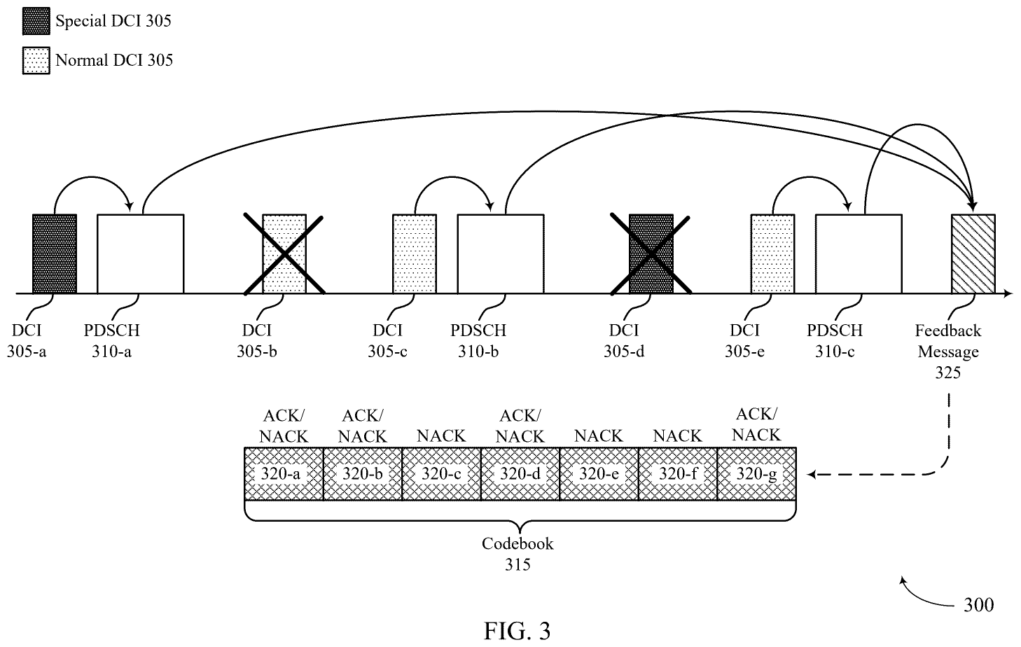

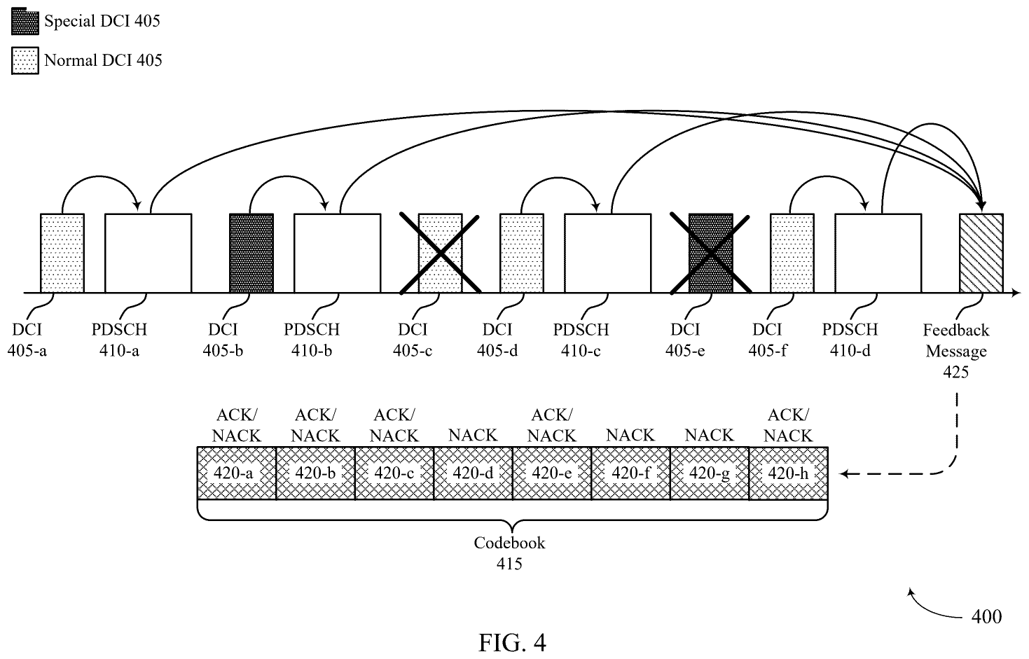

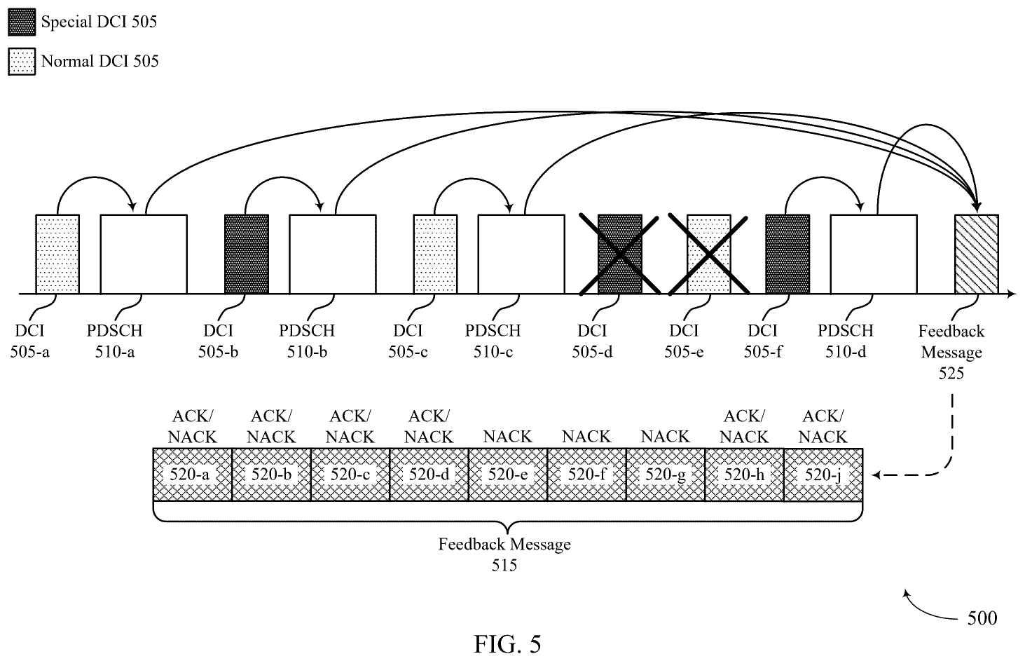

As described herein, ‘X’ may be based on a type of special DCI 205. For example, a first type of special DCI 205 may be a first special DCI 205 that schedules a PDSCH 220 with multiple TBs, where ‘X’ may be equal to a quantity of the multiple TBs, as described herein with reference to FIG. 3. Additionally, or alternatively, a second type of special DCI 205 may be a second special DCI 205 that indicates a reserved MCS, where ‘X’ may be equal to a quantity of TBs scheduled by the second special DCI 205 plus one (e.g., plus one bit 225 for indicating whether a TB size is known by the UE 115-a), as described herein with reference to FIG. 4. Additionally, or alternatively, a third type of special DCI 205 may be a third special DCI 205 that indicates a new state for the UE 115-a, where ‘X’ may be equal to a quantity of TBs scheduled by the third special DCI 205 plus one (e.g., plus one bit for indicating whether the new state was applied by the UE 115-a), as described herein with reference to FIG. 5. In some cases, a value of ‘X’ may be different for each type of special DCI 205 (e.g., for different special DCIs 305). For example, the first type of special DCI 205 may be associated with a value of ‘X’ equal to 2 and the second type of special DCI 205 may be associated with a value of ‘X’ equal to 3.

In some cases, the UE 115-a may identify whether a detected DCI 205 is a special DCI 205 or a normal DCI 205 based on a field in the detected DCI 205. That is, a fourth DCI 205 may include a field (e.g., of 1 bit) that indicates whether the fourth DCI 205 should be considered special or not. For example, if the field is set to 1 in the fourth DCI 205, ‘X’ may equal 2 (e.g., the fourth DCI 205 may be a special DCI 205). That is, a codebook 210 may indicate 2 bits for feedback associated with the fourth DCI 205 (e.g., other than ‘00’ for ACK and NACK of an associated PDSCH 220). For example, a value of ‘11’ of the 2 bits may indicate the fourth DCI 205 was received (e.g., and decoded) by the UE 115-a and a PDSCH scheduled by the fourth DCI 205 was received (e.g., and decoded) by the UE 115-a, a value of ‘01’ or ‘10’ of the 2 bits may indicate the fourth DCI 205 was received (e.g., and decoded) by the UE 115-a and the PDSCH scheduled by the fourth DCI 205 was not received or not decoded by the UE 115-a, and a value of ‘00’ of the 2 bits may indicate the fourth DCI 205 was not received or not decoded (e.g., missed). In some examples, the UE 115 may not be aware that the fourth DCI 205 is a special DCI (because it is missed), and UE 115 may report the value of ‘00’ based on detecting the next DCI and based on seeing a DAI gap (e.g. a gap of two), and the UE 115 may therefore indicate two NACKs (e.g., two 0's).

Thus, the network entity 105-a may distinguish between the fourth DCI 205 being decoded but the associated PDSCH being NACKed, as indicated by ‘01’ or ‘10, and the fourth DCI 205 not being decoded, as indicated by ‘00.’ In some other cases, when ‘X’ is equal to 2 and the fourth DCI 205 schedules ‘Y’ TBs, the codebook 210 may include a first bit indicative of whether the fourth DCI 205 was decoded and one or more second bits including one bit per TB (e.g., the one or more second bits may include ‘Y’ bits), where each bit indicates feedback for a respective TB. Conversely, if the field is set to 0 in the fourth DCI 205, ‘X’ may equal 1 (e.g., the fourth DCI 205 may be a normal DCI 205). That is, the codebook 210 may indicate 1 bits for feedback associated with the fourth DCI 205. In some examples, the network entity 105-a may transmit, to the UE 115-a a control message (e.g., radio resource control (RRC) message) enabling (e.g., activating) the field (e.g., indicating the presence of the field in upcoming DCIs 205). In some examples, the enabling of the field (e.g., configuration of the field) may be per DCI format (e.g., separately configured for DCI format 1_1 versus DCI format 1_2). In some cases, if the field is not present in a DCI 205 (e.g., either not configured to be present for a given DCI format, or for fallback DCI format 1_0), the UE 115-a may determine the DCI 205 is a normal DCI 205 or a special DCI 205 based on a default assumption (e.g., for HARQ-ACK codebook construction). In some cases, the default assumption may be that a DCI 205 (e.g., DCI format) without the field is a normal DCI 205 and, in some other cases, the default assumption may be that a DCI 205 (e.g., DCI format) without the field is a special DCI 205.

Additionally, or alternatively, the UE 115-a may determine whether a detected DCI 205 is a special DCI 205 or a normal DCI 205 based on existing information or fields in the detected DCI 205 (e.g., the detected DCI 205 may not include any information or fields specific to the detected DCI 205 being a special DCI 205 or a normal DCI 205). For example, the UE 15-a may determine a detected DCI 205 is a special DCI 205 based on the detected DCI 205 scheduling multiple TBs. Additionally, or alternatively, the UE 115-a may receive, from the network entity 105-a, a control message (e.g., RRC message) indicating a list of DCI types (e.g., the UE 115-a may be configured to support special DCIs 205 for Type 2 HARQ-ACK codebook generation). For example, the list of DCI types may indicate one or more normal DCIs 205 (e.g., one or more types of normal DCI 205), one or more special DCIs 205 (e.g., one or more types of special DCI 205), or both. In some cases, the list of DCI types may include the first special DCI 205, the second special DCI 205, the third special DCI 205, a fourth DCI 205, or any combination thereof, for which the UE 115-a may assume are associated with a value of ‘X’ that is greater than one. Additionally, or alternatively, the UE 115-a may be preconfigured with the list of DCI types (e.g., based on one or more fixed rules without RRC configuration). In some examples, the list of DCI types may be indicated per cell-group (e.g., for all CCs 230 in a cell-group), per CC 230, or both. Additionally, or alternatively, the UE 115-a may transmit, to the network entity 105-a, a capability message indicating whether the UE 115 supports generating a codebook 210 (e.g., HARQ-ACK codebook) with a different number of bits for special DCIs 205 compared to other (e.g., normal) DCIs 205.

Indicating, to the UE 115-a, whether a detected DCI 205 is a special DCI 205 or a normal DCI 205 (e.g., via the field in the detected DCI 205, based on the list of DCI types) may enable the UE 115-a to provide feedback relative to whether a NACK is due to an associated PDSCH 220 not being received (e.g., or decoded) or is due to the detected DCI 205 not being received (e.g., or decoded), as described herein with reference to FIGS. 3, 4, and 5. In other words (e.g., for some DCIs 205), the network entity 105-a may be able to distinguish between a PDSCH 220 not being received (e.g., or decoded) or a DCI 205 not being received (e.g., or decoded). For example, in some cases (e.g., for some PDSCHs 220), it may be beneficial for the network entity 105-a to know (e.g., be aware of) whether a DCI 205 scheduling an initial transmission of a TB is decoded (e.g., or not) so the network entity 105-a may determine a redundancy version (RV) or modulation and coding scheme (MCS) for a retransmission of the TB if there is a threshold delay budget (e.g., a max of 1 retransmission in addition to the initial transmission). Thus, the network entity 105-a may indicate that the DCI 205 scheduling the initial transmission of the TB is a special DCI 205.

In some cases, as described herein with reference to FIGS. 3, 4, and 5, ‘X’ may be equal to two (e.g., X=2). That is, if ‘X’ is greater than two (e.g., X>2), the UE 115-a may be unable to identify missing DCIs 205 unless a quantity of bits for each DAI field in each DCI 205 is increased (e.g., as compared to 2 bits in NR). That is, 2 bit DAI fields (e.g., cDAI field and tDAI field, modulo 4 operation) may support identification of up to three consecutive missing normal DCIs 205, or up to one missing normal DCI 205 and one missing special DCI 205 (e.g., back-to-back, consecutively). Additionally, in some cases, special DCIs 205 may be transmitted infrequently (e.g., given that two consecutive missing special DCIs may not be detected with 2-bit DAI fields).

Though described in the context of HARQ feedback, DCIs, and PDSCHs, this is not to be regarded as a limitation of the present disclosure. In this regard, any type of feedback, any type of control message (e.g., DCI, RRC, medium access control-control element (MAC-CE)), and any type of scheduled message (e.g., PDSCH, physical uplink control channel (PUSCH)) may be supported with regards to the techniques described herein.

FIG. 3 shows an example of a timing diagram 300 that supports techniques for indicating feedback with unequal quantities of bits per DAI in accordance with one or more aspects of the present disclosure. In some cases, the timing diagram 300 may implement or be implemented by aspects of the wireless communications system 100, wireless communications system 200, or both. For example, the timing diagram 300 may be implemented by one or more UEs 115 and one or more network entities 105, which may be examples of the corresponding devices as described herein.

As described herein, with reference to FIG. 2, a UE 115 may support multiple types of DCIs 305 (e.g., control messages), including a first type of DCI, which may be referred to as a normal DCI 305, and one or more second types of DCI 305, which may be referred to as a special DCIs 305. In such cases, a network entity 105 may increment a DAI value in a normal DCI 305 by one (e.g., from a previous DAI value in a previous DCI 305, normal or special) and may increment a DAI value in a special DCI 305 by more than one (e.g., from a previous DAI value in a previous DCI 305, normal or special).

Additionally, in some cases (e.g., when SpatialBundling is not configured), a special DCI 305 may be a DCI 305 that schedules a PDSCH 310 with a quantity ‘X’ TBs (e.g., or codewords), such that a DAI value in the special DCI 305 may be incremented by ‘X’ from a previous DAI value in a previous DCI 305. As such, ‘X’ bits 320, in a codebook 315, for a DAI value, from a detected special DCI 305 that schedules ‘X’ TBs, may indicate ACK or NACK of the ‘X’ TBs. In other words, the special DCI 305 (e.g., the DAI value indicated in the special DCI 305) may be associated with ‘X’ bits 320 in a codebook 315, where the ‘X’ bits 320 indicate feedback (e.g., ACK or NACK) associated with the ‘X’ TBs scheduled by the special DCI 305. Thus, a size of the codebook 315 may be reduced when a threshold quantity (e.g., most, greater than 50 percent) of DCIs 305 (e.g., associated with a codebook 315) schedule a single TB, and thus are normal DCIs 305 (e.g., as compared to when a same threshold quantity of bits 320 is used per DAI value). Additionally, or alternatively, in some cases, some CCs may not support (e.g., be configured with) multi-TB scheduling, such that if a first CC supports multi-TB scheduling but a second CC does not, the UE may support variable-bit feedback reporting for the first CC and single-bit feedback reporting for the second CC.

For example, a network entity 105 may transmit a special DCI 305-a, a normal DCI 305-b, a normal DCI 305-c, a special DCI 305-d, and a normal DCI 305-c. In such cases, the special DCI 305-a and the special DCI 305-d may each schedule 2 TBs (e.g., X=2), whereas the normal DCI 305-b, the normal DCI 305-c, and the normal DCI 305-e may each schedule 1 TB. In some cases, the UE 115 may receive the special DCI 305-a, where the special DCI 305-a indicates a DAI value of 2 based on the special DCI 305-a being a first DCI 305 associated with a codebook 315 (e.g., based on the special DCI 305-a scheduling 2 TBs in a PDSCH 310-a). As such, the UE 115 may indicate feedback (e.g., ACK or NACK) for the 2 TBs scheduled by the special DCI 305-a via a bit 320-a (e.g., associated with a DAI value of 1) and a bit 320-b (e.g., associated with a DAI value of 2) in the codebook 315. Conversely, the UE 115 may fail to receive or fail to decode the normal DCI 305-b, where the normal DCI 305-b indicates a DAI value of 3 based on the network entity 105 incrementing the DAI value of 2 in the special DCI 305-a (e.g., a previous DCI 305) by 1 (e.g., based on the normal DCI 305-b scheduling 1 TB)

Additionally, the UE 115 may receive the normal DCI 305-c, where the normal DCI 305-c indicates a DAI value of 4 based on the network entity 105 incrementing the DAI value of 3 in the normal DCI 305-b (e.g., a previous DCI 305) by 1 (e.g., based on the normal DCI 305-c scheduling 1 TB in a PDSCH 310-b). Thus, the UE 115 may identify that the UE 115 missed the DAI value of 3 (e.g., missed the normal DCI 305-b). As such, the UE 115 may indicate a NACK (e.g., associated with the normal DCI 305-b) via a bit 320-c associated with the DAI value of 3 in the codebook 315 based on missing the DAI value of 3 (e.g., failing to receive or failing to decode the normal DCI 305-b). Additionally, the UE 115 may indicate feedback (e.g., ACK or NACK) for the TB scheduled by the normal DCI 305-c via a bit 320-d in the codebook 315.

Additionally, the UE 115 may fail to receive or fail to decode the special DCI 305-d, where the special DCI 305-d indicates a DAI value of 2 (e.g., a DAI value of 6) based on the network entity 105 incrementing the DAI value of 4 in the normal DCI 305-c (e.g., a previous DCI 305) by 2 (e.g., based on the special DCI 305-d scheduling 2 TB). Further, the UE 115 may receive the normal DCI 305-e, where the normal DCI 305-e indicates a DAI value of 3 (e.g., a DAI value of 7) based on the network entity 105 incrementing the DAI value of 2 in the special DCI 305-d (e.g., a previous DCI 305) by 1 (e.g., based on the normal DCI 305-e scheduling 1 TB in a PDSCH 310-c). Thus, the UE 115 may identify that the UE 115 missed the DAI values of 1 and 2 (e.g., missed the special DCI 305-d). As such, the UE 115 may indicate a NACK (e.g., associated with the special DCI 305-d) in each of a bit 320-e, in the codebook 315, associated with the DAI value of 1, and a bit 320-f, in the codebook 315, associated with the DAI value of 2, based on missing the DAI values of 1 and 2 (e.g., failing to receive or failing to decode the special DCI 305-d). In such cases, the UE 115 may not be aware of whether the UE 115 missed two normal DCIs 305 or a single special DCI 305. However, once the UE 115 reports the codebook 315 (e.g., HARQ-ACK codebook) with NACKs of the bit 320-e and the bit 320-f, the network entity 105 may identify that the reason for the NACKs is due to the UE 115 missing one special DCI 305 (e.g., the special DCI 305-d). Additionally, the UE 115 may indicate feedback (e.g., ACK or NACK) for the TB scheduled by the normal DCI 305-e via a bit 320-g in the codebook 315. Thus, the UE 115 may transmit, to the network entity 105, a feedback message 325 indicating the codebook 315.

Though described in the context of special DCIs 305 scheduling 2 TBs (e.g., X=2), this is not to be regarded as a limitation of the present disclosure. In this regard, the special DCIs 305 may schedule any quantity of TBs. Further, each special DCI 305 may schedule a different quantity of TBs, such that each special DCI 305 may be associated with a respective value of ‘X.’

FIG. 4 shows an example of a timing diagram 400 that supports techniques for indicating feedback with unequal quantities of bits per DAI in accordance with one or more aspects of the present disclosure. In some cases, the timing diagram 400 may implement or be implemented by aspects of the wireless communications system 100, wireless communications system 200, the timing diagram 300, or any combination thereof. For example, the timing diagram 400 may be implemented by one or more UEs 115 and one or more network entities 105, which may be examples of the corresponding devices as described herein.

As described herein, with reference to FIG. 2, a UE 115 may support multiple types of DCIs 405 (e.g., control messages), including a first type of DCI, which may be referred to as a normal DCI 405, and one or more second types of DCI 405, which may be referred to as a special DCIs 405. In such cases, a network entity 105 may increment a DAI value in a normal DCI 405 by one (e.g., from a previous DAI value in a previous DCI 405, normal or special) and may increment a DAI value in a special DCI 405 by more than one (e.g., from a previous DAI value in a previous DCI 405, normal or special).

Additionally, in some cases, a special DCI 405 may be a DCI 405 that indicates a reserved MCS value (e.g., an MCS entry that indicates a modulation order but does not indicate a coding rate, i.e., with reserved coding rate). That is, if a first DCI 405 scheduling an initial transmission for a TB is missed, and the network entity 105 indicates a reserved MCS in a second DCI 405 for scheduling retransmissions of the TB, the UE 115 may not be able to decode the TB as a TB size associated with the TB may be unknown (e.g., based on missing the first DCI 405). In other words, from the UE 115 perspective, the second DCI 405 may schedule an initial transmission of the TB, however, the UE 115 may not be able to determine the TB size (e.g., given a coding rate is not indicated by the reserved MCS, only modulation order is indicated). Thus, to enable the UE 115 to indicate whether the second DCI 405 was decoded (e.g., and whether the UE 115 knows the TB size), the second DCI 405 may be a special DCI 405.

In such cases, a DAI value associated with a special DCI 405 may be incremented by a quantity ‘X’ relative to a previous DAI value in a previous DCI 405. In some cases, the quantity ‘X’ may be equal to a first quantity of TBs (e.g., ‘X−1’ TBs) scheduled by the special DCI 405 plus one the quantity ‘X’ may be equal to 2 for the special DCI 405 (e.g., for the cases that DAI is incremented by 1 in normal DCIs 405 irrespective of a quantity of scheduled TBs scheduled by the special DCI 405). As such, ‘X’ bits 420, in a codebook 415, for a DAI value, from a detected special DCI 405 that schedules the first quantity of TBs, may indicate, via a first bit (e.g., of the ‘X’ bits 420), whether a TB size (e.g., associated with the special DCI 405) is known by the UE (e.g., whether the TB size is missing, whether a code rate based on the TB size is missing) and may indicate, via one or more second bits, ACK or NACK of the first quantity of TBs. In other words, the special DCI 405 (e.g., the DAI value indicated in the special DCI 305) may be associated with ‘X’ bits 420 in a codebook 415, where the ‘X’ bits 420 indicate feedback (e.g., ACK or NACK) associated with ‘X−1’ TBs scheduled by the special DCI 405 and whether the UE 115 decoded the special DCI 405 (e.g., whether the UE 115 knows the TB size or the code rate). In some cases, when ‘X’ is equal to the first quantity of TBs (e.g., ‘X−1’ TBs) scheduled by the special DCI 405 plus one, the one or more second bits may include one bit per TB in the first quantity of TBs (e.g., the one or more second bits may include ‘X−1’ bits), where each bit indicates feedback for a respective TB. In some other cases, when ‘X’ is equal to 2 and the special DCI 405 schedules ‘Y’ TBs, the one or more second bits may include one bit per TB (e.g., the one or more second bits may include ‘Y’ bits), where each bit indicates feedback for a respective TB. In some other cases, when ‘X’ is equal to 2, the one or more second bits may include one bit indicative of feedback for the first quantity of TBs (e.g., the one bit may indicate NACK if at least one TB of the first quantity of TBs is not decoded).

For example, a special DCI 405 indicating a reserved MCS may schedule 1 TB (e.g., in a PDSCH 410) associated with a TB size, such that 2 bits 420 (e.g., X=2) in a codebook 415 indicate whether the TB was received and decoded and indicate whether the UE 115 knows the TB size (e.g., knows a code rate based on the TB size). In some aspects, the bits 420 may jointly indicate (e.g., be jointly interpreted to identify) one of multiple (e.g., four) possible scenarios associated with the special DCI 405, the PDSCH 410, and/or the TBS. For example, a value of ‘11’ of the 2 bits may indicate that the UE 115 decoded the PDSCH 410 (e.g., decoded the TB, and hence, UE decoded the special DCI 405 and also knows the TB size), a value of ‘10’ of the 2 bits may indicate that the UE 115 did not decode the PDSCH 410 but the UE 115 decoded the special DCI 405 and also knows the TB size (e.g., the network entity 105 may continue to use the reserved MCS for a next retransmission of the TB), a value of ‘01’ of the 2 bits may indicate that the UE 115 does not know the TB size. That is, the value of ‘01’ may indicate that the UE 115 decoded the special DCI 405, but since the UE 115 did not decode a previous DCI 405 scheduling an initial transmission of the TB, the UE 115 does not know the TB size, and hence, cannot decode the PDSCH 410 (e.g., the network entity 105 may indicate an explicit MCS for the next retransmission of the TB), and a value of ‘00’ of the 2 bits may indicate that the UE 115 did not decode (e.g., missed) the special DCI 405. In some cases, the special DCI 405 may be associated with a CRC scrambled with a cell-ratio network temporary identifier (C-RNTI). In some cases, the special DCI 405 may not be associated with a CRC scrambled with a configured scheduling-RNTI (CS-RNTI) based on the UE 115 knowing the TB size for semi-persistent scheduling (SPS) retransmissions.

As an illustrative example, as depicted in FIG. 4, a network entity 105 may transmit a normal DCI 405-a, a special DCI 405-b, a normal DCI 405-c, a normal DCI 405-d, a special DCI 405-c, and a normal DCI 405-f. In such cases, the special DCI 405-b and the special DCI 405-e may each schedule 1 TB and may indicate a reserved MCS, whereas the normal DCI 405-a, the normal DCI 405-c, the normal DCI 405-d, and the normal DCI 405-f may each schedule 1 TB and may not indicate a reserved MCS. In some cases, the UE 115 may receive the normal DCI 405-a, where the normal DCI 405-a indicates a DAI value of 1 based on the normal DCI 405-a being a first DCI 405 associated with a codebook 415 (e.g., based on the normal DCI 405-a scheduling 1 TB via a PDSCH 410-a and not indicating a reserved MCS). As such, the UE 115 may indicate feedback (e.g., ACK or NACK) for the 1 TB scheduled by the normal DCI 405-a via a bit 420-a (e.g., associated with a DAI value of 1) in the codebook 415.

Additionally, the UE 115 may receive the special DCI 405-b, where the special DCI 405-b indicates a DAI value of 3 based on the network entity 105 incrementing the DAI value of 1 in the normal DCI 405-a (e.g., a previous DCI 405) by 2 (e.g., based on the special DCI 405-b scheduling 1 TB via a PDSCH 410-b and indicating a first reserved MCS). As such, the UE 115 may indicate whether the UE 115 knows a TB size associated with the first reserved MCS and indicate feedback (e.g., ACK or NACK) for the 1 TB scheduled by the special DCI 405-b via a bit 420-b (e.g., associated with a DAI value of 2) and a bit 420-c (e.g., associated with a DAI value of 3) in the codebook 415. For example, the UE 115 may indicate ‘11’ via the bit 420-b and the bit 420-c based on the UE 115 knowing the TB size and decoding the PDSCH 410-b, may indicate ‘10’ via the bit 420-b and the bit 420-c based on the UE 115 knowing the TB size but failing to decode the PDSCH 410-b, or may indicate ‘01’ via the bit 420-b and the bit 420-c based on the UE 115 missing the TB size but decoding the PDSCH 410-b.

Conversely, the UE 115 may fail to receive or fail to decode the normal DCI 405-c, where the normal DCI 405-c indicates a DAI value of 4 based on the network entity 105 incrementing the DAI value of 3 in the special DCI 405-b (e.g., a previous DCI 405) by 1 (e.g., based on the normal DCI 405-c scheduling 1 TB and not indicating a reserved MCS). Additionally, the UE 115 may receive the normal DCI 405-d, where the normal DCI 405-d indicates a DAI value of 1 (e.g., a DAI value of 5) based on the network entity 105 incrementing the DAI value of 4 in the normal DCI 405-c (e.g., a previous DCI 405) by 1 (e.g., based on the normal DCI 405-d scheduling 1 TB via a PDSCH 410-c and not indicating a reserved MCS). Thus, the UE 115 may identify that the UE 115 missed the DAI value of 4 (e.g., missed the normal DCI 405-c). As such, the UE 115 may indicate a NACK (e.g., associated with the normal DCI 405-c) via a bit 420-d associated with the DAI value of 4 in the codebook 415 based on missing the DAI value of 4 (e.g., failing to receive or failing to decode the normal DCI 405-c). Additionally, the UE 115 may indicate feedback (e.g., ACK or NACK) for the PDSCH 410-c (e.g., scheduled by the normal DCI 405-d) via a bit 420-e in the codebook 415.

Additionally, the UE 115 may fail to receive or fail to decode the special DCI 405-c, where the special DCI 405-e indicates a DAI value of 3 (e.g., a DAI value of 7) based on the network entity 105 incrementing the DAI value of 1 in the normal DCI 405-d (e.g., a previous DCI 405) by 2 (e.g., based on the special DCI 405-e scheduling 1 TB and indicating a second reserved MCS). Further, the UE 115 may receive the normal DCI 405-f, where the normal DCI 405-f indicates a DAI value of 4 (e.g., a DAI value of 8) based on the network entity 105 incrementing the DAI value of 3 in the special DCI 405-e (e.g., a previous DCI 405) by 1 (e.g., based on the normal DCI 405-f scheduling 1 TB in a PDSCH 410-d and not indicating a reserved MCS). Thus, the UE 115 may identify that the UE 115 missed the DAI values of 2 and 3 (e.g., missed the special DCI 405-c). As such, the UE 115 may indicate a NACK (e.g., associated with the special DCI 405-c) in each of a bit 420-f, in the codebook 415, associated with the DAI value of 2, and a bit 420-g, in the codebook 415, associated with the DAI value of 3, based on missing the DAI values of 2 and 3 (e.g., failing to receive or failing to decode the special DCI 405-c). In such cases, the UE 115 may not be aware of whether the UE 115 missed two normal DCIs 405 or a single special DCI 405. Additionally, the UE 115 may indicate feedback (e.g., ACK or NACK) for the PDSCH 410-d (e.g., scheduled by the normal DCI 405-f) via a bit 420-h in the codebook 415. Thus, the UE 115 may transmit, to the network entity 105, a feedback message 425 indicating the codebook 415.

Though described in the context of special DCIs 405 scheduling 1 TB (e.g., X=2), this is not to be regarded as a limitation of the present disclosure. In this regard, the special DCIs 405 may schedule any quantity of TBs. Further, each special DCI 405 may schedule a different quantity of TBs, such that each special DCI 405 may be associated with a respective value of ‘X.’

FIG. 5 shows an example of a timing diagram 500 that supports techniques for indicating feedback with unequal quantities of bits per DAI in accordance with one or more aspects of the present disclosure. In some cases, the timing diagram 500 may implement or be implemented by aspects of the wireless communications system 100, wireless communications system 200, the timing diagram 300, the timing diagram 400, or any combination thereof. For example, the timing diagram 500 may be implemented by one or more UEs 115 and one or more network entities 105, which may be examples of the corresponding devices as described herein.

As described herein, with reference to FIG. 2, a UE 115 may support multiple types of DCIs 505 (e.g., control messages), including a first type of DCI, which may be referred to as a normal DCI 505, and one or more second types of DCI 505, which may be referred to as a special DCIs 505. In such cases, a network entity 105 may increment a DAI value in a normal DCI 505 by one (e.g., from a previous DAI value in a previous DCI 505, normal or special) and may increment a DAI value in a special DCI 505 by more than one (e.g., from a previous DAI value in a previous DCI 505, normal or special).

Additionally, in some cases, a special DCI 505 may be a DCI 505 that schedules a PDSCH 510 with a first quantity TBs (e.g., or codewords) and indicates an action to be performed by the UE 115 (e.g., via a DCI payload, via a field of the DCI 505). In some cases, the action indicated by the special DCI 505 may result in the UE 115 transitioning to a new state. For example, the following special DCIs 505 (e.g., downlink grants, DCI format 1_1, DCI format 1_2) may each schedule a first quantity of TBs in addition to triggering (e.g., indicating) an associated action (e.g., and hence have associated HARQ-ACK):
1. A first special DCI 505 indicating a new transmission configuration indicator (TCI) state: The first special DCI 505 may indicate a new TCI state via a TCI field in the first special DCI 505, where the UE 115 may switch to the new TCI state (e.g., new beam) a given duration after feedback triggered by the first special DCI 505.
2. A second special DCI 505 indicating a BWP change: The second special DCI 505 may indicate a BWP change via a BWP indicator field in the second special DCI 505 that indicates (e.g., points to) a BWP different from a current active BWP.
3. A third special DCI 505 indicating a search space set (SSS) group switch: The third special DCI 505 may indicate one of up to three configured (e.g., RRC-configured) SSS groups via a PDCCH monitoring adaptation field in the third special DCI 505. In such cases, the UE 115 may begin (e.g., start) to monitor PDCCH in the indicated SSS group a first threshold duration after a last symbol of the third special DCI 505.
4. A fourth special DCI 505 indicating PDCCH skipping: The fourth special DCI 505 may indicate one of a set of durations (e.g., RRC-configured durations, including no skipping) through a PDCCH monitoring adaptation field in the fourth special DCI 505. In such cases, the UE 115 may skip monitoring PDCCH (e.g., in a UE-specific search space (USS) or a Type 3 common search space (CSS)) for the indicated duration, where the indicated duration starts a second threshold duration after a last symbol of the fourth special DCI 505.
5. A fifth special DCI 505 indicating secondary cell (SCell) dormancy: The fifth special DCI 505 may indicate one or more SCell groups to switch to or from dormancy via an SCell dormancy indication field in the fifth special DCI 505. In such cases, the UE 115 may transition the indicated one or more SCell groups to or from dormancy a third threshold duration after a last symbol of the fifth special DCI 505.
6. A sixth special DCI 505 indicating a scheduling offsets (e.g., minimum K0 or K2): The sixth special DCI 505 may indicate a new threshold (e.g., minimum) scheduling offset via a minimum applicable scheduling offset indicator field in the sixth special DCI 505. In such cases, up to two values for each of a first scheduling offset (e.g., minKO) and a second scheduling offset (e.g., minK2) may be supported by the UE 115 (e.g., may be configured via RRC), such that the minimum applicable scheduling offset indicator field (e.g., 1 bit) may indicate one of the supported values. Additionally, the UE 115 may apply the indicated scheduling offset a fourth threshold duration (e.g., Y slots, where Y is based on a current minKO, subcarrier spacing (SCS) of PDCCH, or the like thereof) from a slot (e.g., slot n) during which the sixth special DCI 505 was received (e.g., the indicated scheduling offset is applied in slot n+Y).

This list of special DCIs 505 is not to be understood as an exhaustive list of special DCIs 505 scheduling a first quantity of TBs in addition to triggering an associated action, and is merely an exemplary list of special DCIs 505, such that other special DCIs 505 scheduling a first quantity of TBs in addition to triggering an associated action may be considered with regards to the techniques described herein.

In such cases, for a special DCI 505 triggering a new state of the UE 115, it may be beneficial for the network entity 105 to know whether a reported NACK is due to PDSCH decoding failure but the special DCI 505 is decoded (e.g., the UE 115 may transition to a new state, the new state may be assumed by the network entity 105) or whether the reported NACK is due to missing (e.g., failing to receive or decode) the special DCI 505 (e.g., the UE 115 may not transition to the new state, the new state may not be assumed by the network entity 105). Thus, to enable the network entity 105 to distinguish between the aforementioned cases, a DAI value in a special DCI 505 may be incremented by a quantity ‘X’ from a previous DAI value in a previous DCI 505. In some cases, the quantity ‘X’ may be equal to a first quantity of TBs (e.g., ‘X−1’ TBs) scheduled by the special DCI 505 plus one, or, in some other cases, the quantity ‘X’ may be equal to 2 for the special DCI 505 (e.g., for cases that DAI is incremented by 1 in normal DCIs 505 irrespective of a quantity of TBs scheduled by the special DCI 505). That is, ‘X’ bits 520 (e.g., in a codebook 515) for a DAI value (e.g., from a detected special DCI 505) may indicate, via a first bit (e.g., of the ‘X’ bits 420), whether the indicated action was performed by the UE 115 (e.g., whether the UE 115 decoded the special DCI 505) and may indicate, via one or more second bits, ACK or NACK of a first quantity of TBs (e.g., ‘X−1’ TBs) scheduled by the special DCI 505. In some examples, where ‘X’ is equal to the first quantity of TBs (e.g., ‘X−1’ TBs) scheduled by the special DCI 505 plus one, the special DCI 505 (e.g., the DAI value indicated in the special DCI 505) may be associated with ‘X’ bits 520 in a codebook 515, where the ‘X’ bits 520 indicate feedback (e.g., ACK or NACK) associated with ‘X−1’ TBs scheduled by the special DCI 505 and indicate whether the UE 115 performed the action indicated by the special DCI 505 (e.g., decoded the special DCI 505). In some examples, a DAI in a DCI (e.g., a normal DCI) is incremented by one and DAI in special DCI 505 is incremented by two (e.g., irrespective of number of scheduled TBs). In some other cases, when ‘X’ is equal to 2 and the special DCI 505 schedules ‘Y’ TBs, the one or more second bits may include one bit per TB (e.g., the one or more second bits may include ‘Y’ bits), where each bit indicates feedback for a respective TB. In some other cases, where ‘X’ is equal to 2, the special DCI 505 may be associated with 2 bits 520 in a codebook 515, where the 2 bits 520 indicate feedback where a first bit 520 indicates whether the ‘X−1’ TBs scheduled by the special DCI 505 were decoded (e.g., indicates a NACK if at least one TB was not decoded) and a second bit indicates whether the UE 115 performed the action indicated by the special DCI 505 (e.g., whether the special DCI is decoded by the UE 115).

For example, a special DCI 505, triggering (e.g., indicating) an action (e.g., state change), may schedule 1 TB (e.g., in a PDSCH 510), such that 2 bits 520 (e.g., X=2) in a codebook 515 indicate whether the TB was received and decoded and indicate whether the UE 115 performed the action (e.g., performed the state change, transitioned to the new state, decoded the special DCI 505). For example, a value of ‘11’ of the 2 bits may indicate that the UE 115 performed the action and decoded the PDSCH 510 (e.g., decoded the TB), a value of ‘10’ or ‘01’ of the 2 bits may indicate that the UE 115 performed the action but did not decode the PDSCH 510, and a value of ‘00’ of the 2 bits may indicate that the UE 115 did not decode (e.g., missed) the special DCI 505 (e.g., and thus did not perform the action). In some cases, a DCI 505 that indicates an action (e.g., a new state) but does not schedule a TB (e.g., a PDSCH 510), the DCI 505 may not be considered a special DCI 505 (e.g., due to 1-bit ACK or NACK in the codebook 515 identifying whether the DCI 505 was decoded or not).

As described herein, a special DCI 505 may be any of the first special DCI 505 (e.g., the new state is based on a TCI state change), the second special DCI 505 (e.g., the new state is based on active BWP switching), the third special DCI 505 (e.g., the new state is based on SSS group switching), the fourth special DCI 505 (e.g., the new state is based on PDCCH monitoring skipping for a duration), the fifth special DCI 505 (e.g., the new state is based on SCell group transition to or from dormancy), the sixth special DCI 505 (e.g., the new state is based on a change in minimum scheduling offset), or the like thereof. In some cases, a list of special DCIs 505 may be indicated to the UE 115 (e.g., by the network entity 105 via control signaling) or may be pre-configured at the UE 115, such that the UE 115 may know when to indicate feedback via 1 bit (e.g., for normal DCIs 505) or more than 1 bit 520 (e.g., for special DCIs 505).

As an illustrative example, as depicted in FIG. 5, a network entity 105 may transmit a normal DCI 505-a, a special DCI 505-b, a normal DCI 505-c, a special DCI 505-d, a normal DCI 505-c, and a special DCI 505-f. In such cases, the special DCI 505-b, the special DCI 505-d, and the special DCI 505-f may each schedule 1 TB and may indicate an action to be performed by the UE 115 (e.g., X=2), whereas the normal DCI 505-a, the normal DCI 505-c, and the normal DCI 505-e may each schedule 1 TB and may not indicate an action to be performed by the UE 115. In some cases, the UE 115 may receive the normal DCI 505-a, where the normal DCI 505-a indicates a DAI value of 1 based on the normal DCI 505-a being a first DCI 505 associated with a codebook 515 (e.g., based on the normal DCI 505-a scheduling 1 TB via a PDSCH 510-a and not indicating an action to be performed by the UE 115). As such, the UE 115 may indicate feedback (e.g., ACK or NACK) for the 1 TB scheduled by the normal DCI 505-a via a bit 520-a (e.g., associated with a DAI value of 1) in the codebook 515.

Additionally, the UE 115 may receive the special DCI 505-b, where the special DCI 505-b indicates a DAI value of 3 based on the network entity 105 incrementing the DAI value of 1 in the normal DCI 505-a (e.g., a previous DCI 505) by 2 (e.g., based on the special DCI 505-b scheduling 1 TB via a PDSCH 510-b and indicating a first action to be performed by the UE 115). As such, the UE 115 may indicate whether the UE 115 performed the first action and indicate feedback (e.g., ACK or NACK) for the 1 TB scheduled by the special DCI 505-b via a bit 520-b (e.g., associated with a DAI value of 2) and a bit 520-c (e.g., associated with a DAI value of 3) in the codebook 515. For example, the UE 115 may indicate ‘11’ via the bit 520-b and the bit 520-c based on the decoding the PDSCH 510-b (e.g., ACK) or may indicate ‘01’ or ‘10’ via the bit 520-b and the bit 520-c based on the UE 115 failing to decode the PDSCH 510-b (e.g., NACK).

Additionally, the UE 115 may receive the normal DCI 505-c, where the normal DCI 505-c indicates a DAI value of 4 based on the network entity 105 incrementing the DAI value of 3 in the special DCI 505-b (e.g., a previous DCI 505) by 1 (e.g., based on the normal DCI 505-c scheduling 1 TB via a PDSCH 510-c and not indicating an action to be performed by the UE 115). As such, the UE 115 may indicate feedback (e.g., ACK or NACK) for the 1 TB scheduled by the normal DCI 505-c via a bit 520-d (e.g., associated with a DAI value of 4) in the codebook 515. Conversely, the UE 115 may fail to receive or fail to decode the special DCI 505-d, where the special DCI 505-d indicates a DAI value of 2 (e.g., a DAI value of 6) based on the network entity 105 incrementing the DAI value of 4 in the normal DCI 505-c (e.g., a previous DCI 505) by 2 (e.g., based on the special DCI 505-d scheduling 1 TB and indicating a second action to be performed by the UE 115). Additionally, the UE 115 may fail to receive or fail to decode the normal DCI 505-e, where the normal DCI 505-e indicates a DAI value of 3 (e.g., a DAI value of 8) based on the network entity 105 incrementing the DAI value of 2 in the special DCI 505-d (e.g., a previous DCI 505) by 1 (e.g., based on the normal DCI 505-e scheduling 1 TB and not indicating an action to be performed by the UE 115).

Further, the UE 115 may receive the special DCI 505-f, where the special DCI 505-f indicates a DAI value of 1 (e.g., a DAI value of 9) based on the network entity 105 incrementing the DAI value of 3 in the normal DCI 505-e (e.g., a previous DCI 505) by 2 (e.g., based on the special DCI 505-f scheduling 1 TB in a PDSCH 510-d and indicating a third action to be performed by the UE 115). As such, the UE 115 may indicate whether the UE 115 performed the third action and indicate feedback (e.g., ACK or NACK) for the 1 TB scheduled by the special DCI 505-f via a bit 520-h (e.g., associated with a DAI value of 4) and a bit 520-j (e.g., associated with a DAI value of 1) in the codebook 515. For example, the UE 115 may indicate ‘11’ via the bit 520-h and the bit 520-j based on the decoding the PDSCH 510-d (e.g., ACK) or may indicate ‘01’ or ‘10’ via the bit 520-h and the bit 520-j based on the UE 115 failing to decode the PDSCH 510-d (e.g., NACK).

Additionally, the UE 115 may identify that the UE 115 missed the DAI values of 2, 3, and 4 (e.g., missed the special DCI 505-d and the normal DCI 505-c). That is, to identify that the UE 115 missed 3 DAI values (e.g., rather than seeing the DAI value increment by 1 between the normal DCI 505-c and the special DCI 505-f indicating no missing DAI value), the UE 115 may compare a value of (V−X) mod (4)+1, which may be equal to (1−2)mod(4)+1=4 based on the special DCI 505-f indicating a DAI value of 1 (e.g., V=4) and based on the special DCI 505-f scheduling 1 TB and indicating the third action to be performed by the UE 115 (e.g., X=2). As such, the UE 115 may indicate a NACK (e.g., associated with the special DCI 505-d and the normal DCI 505) in each of a bit 520-c, in the codebook 515, associated with the DAI value of 2, a bit 520-f, in the codebook 515, associated with the DAI value of 3, and a bit 520-g, in the codebook 515, associated with the DAI value of 4, based on missing the DAI values of 2, 3, and 4 (e.g., failing to receive or failing to decode the special DCI 505-d and the normal DCI 505-c). In such cases, the UE 115 may not be aware of whether the UE 115 missed three normal DCIs 505 or a special DCI 505 and a normal DCI 505. Thus, the UE 115 may transmit, to the network entity 105, a feedback message 525 indicating the codebook 515.

Though described in the context of special DCIs 505 scheduling 1 TB (e.g., X=2), this is not to be regarded as a limitation of the present disclosure. In this regard, the special DCIs 505 may schedule any quantity of TBs. Further, each special DCI 505 may schedule a different quantity of TBs, such that each special DCI 505 may be associated with a respective value of ‘X.’

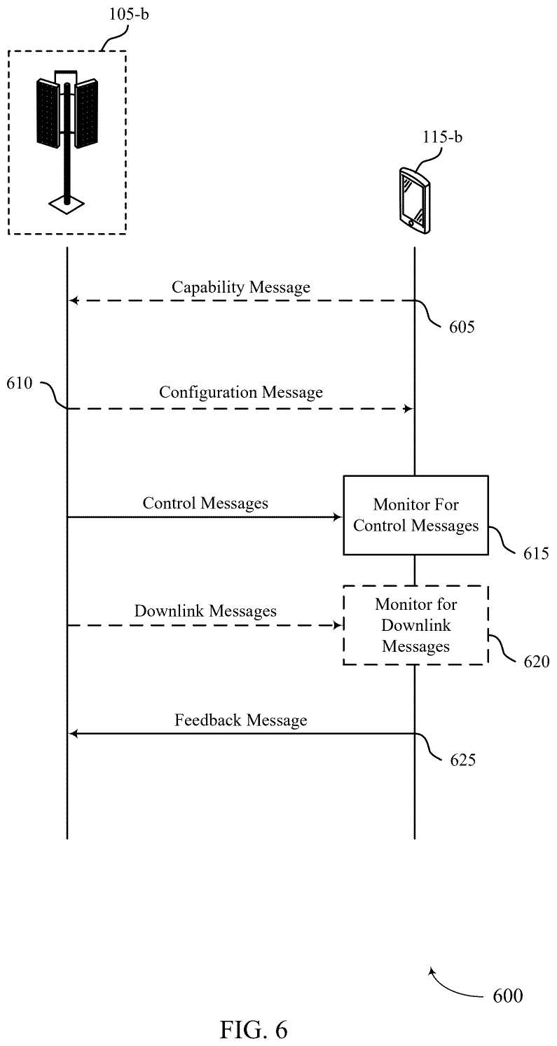

FIG. 6 shows an example of a process flow 600 that supports techniques for indicating feedback with unequal quantities of bits per DAI in accordance with one or more aspects of the present disclosure. In some cases, the wireless communications system 200 may implement or be implemented by aspects of the wireless communications system 100, the wireless communications system 200, the timing diagram 300, the timing diagram 400, the timing diagram 500, or any combination thereof. For example, the wireless communications system 200 may include one or more UEs 115 (e.g., a UE 115-b) and one or more network entities 105 (e.g., a network entity 105-b), which may be examples of the corresponding devices as described herein. In the following description of the process flow 600, the operations between the UE 115-b and the network entity 105-b may be transmitted in a different order than the example order shown, or the operations performed by the UE 115-b and the network entity 105-b may be performed in different orders or at different times. Some operations may also be omitted from the process flow 600, and other operations may be added to the process flow 600.

In some cases, at 605, the UE 115-b may transmit, to the network entity 105-b, a capability message indicating a capability of the UE 115-b to support multiple types of control information messages (e.g., DCIs), including at least a first type of control information message (e.g., a first special DCI) and a second type of control information message (e.g., a second special DCI or a normal DCI).

In some cases, each type of control information message may be associated with a different quantity of bits used to indicate feedback for one or more downlink messages (e.g., PDSCHs) scheduled by a respective control information message. For example, the first type of control information message may be associated with a quantity of bits equal to a first value and the second type of control information message may be associated with a quantity of bits equal to a second value. In some cases (e.g., the second type of control message is the normal DCI), the first value may be greater than 1 (e.g., X≥2) and the second value may be 1 (e.g., X=1). In some other cases (e.g., the second type of control message is the second special DCI), both the first value and the second value may be greater than 1 (e.g., X≥2).

In some cases, at 610, the UE 115-b may receive, from the network entity 105-b, a configuration message (e.g., RRC message) indicating a configuration associated with the multiple types of control information messages. In some cases, the configuration message may include a list of the multiple types of control messages. Additionally, or alternatively, the UE 115 may be pre-configured with list of the multiple types of control messages (e.g., preconfigured with the multiple types of control messages). In either cases, the multiple types of control information messages may be configured per cell-group, per-CC, or both. That is, each cell-group, each CC, or both, may be associated with a different list of types of control information messages.

At 615, the UE 115-b may monitor for and the network entity 105-b multiple control information messages that each schedule one or more downlink messages, where the multiple control information messages includes at least a first control information message. In such cases, a first value of a counter field (e.g., DAI field) of the first control information message may be incremented (e.g., by the network entity 105-b) from a second value of the counter field of a previous control information message (e.g., received or not by the UE 115-b). A difference between the first value and the second value may be based on whether the first control information message is associated with the first type of control information message or the second type of control information message.

For example, in some cases, the difference between the first value and the second value may be greater than one based on the first control information message being associated with the first type of control information message (e.g., being the first special DCI) and may be one based on the first control information message being associated with the second type of control information message (e.g., being the normal DCI). In another example, the difference between the first value and the second value may be a third value (e.g., greater than one) based on the first control information message being associated with the first type of control information message (e.g., being the first special DCI) and may be a fourth value (e.g., greater than one) based on the first control information message being associated with the second type of control information message (e.g., the second special DCI), where the third value and the fourth value are different.

In some cases, at 620, the network entity 105-b may transmit the downlink messages scheduled by the multiple control information messages and the UE 115-b may monitor for at least a subset of the downlink messages, where the at least subset includes the one or more first downlink messages.

At 625, the UE 115-b may transmit, to the network entity 105-b, a feedback message indicating feedback (e.g., codebook) for the one or more downlink messages, where a quantity of bits used to indicate the feedback for one or more first downlink messages associated with the first control information message is based on whether the first control information message is associated with the first type of control information message or the second type of control information message.

In some cases, the first control information message may include a field indicate whether the first control information message is associated with the first type of control information message or the second type of control information message. For example, a first value of the field may indicate that the first control information message is associated with the first type of control information message and a second value of the field may indicate the first control information message is associated with the second type of control information message. In such cases, the first type of control information may be associated with multiple bits being used to indicate the feedback for the one or more first downlink messages, where a first bit of the multiple bits indicates whether the first control information message was decoded and a second bit of the multiple bits may indicate whether the one or more first downlink messages were decoded.

In some cases, the first control information message may be associated with the first type of control information message based on the first control information message excluding a field indicating whether the first control information message is associated with the first type of control information message or the second type of control information message. In some other cases, the first control information message may be associated with the second type of control information message based on the first control information message excluding a field indicating whether the first control information message is associated with the first type of control information message or the second type of control information message

In some cases, the first control information message may be associated with the first type of control information message (e.g., the first special DCI) based on the first control information scheduling multiple first downlink messages. In such cases, both the difference between the first value and the second value and the quantity of bits used to indicate feedback for the multiple first downlink messages may be equal to a first quantity of the multiple first downlink messages based on the first control information message being associated with the first type of control information message (e.g., being a special DCI). For example, a first bit value for a bit of the quantity of bits may indicate that a respective first downlink message of the multiple first downlink messages was decoded, and a second bit value for the bit of the quantity of bits may indicate that the respective first downlink message of the multiple first downlink messages was not decoded (e.g., was not received or was not decoded).

In some other cases, the first control information message may be associated with the first type of control information message (e.g., the first special DCI) based on the first control information indicating a reserved MCS. In such cases, both the difference between the first value and the second value and the quantity of bits used to indicate feedback for the multiple first downlink messages may be equal to one more than a second quantity of the one or more first downlink messages based on the first control information message being associated with the first type of control information message (e.g., being a special DCI). For example, a first bit used to indicate the feedback for the one or more first downlink messages may indicate whether the UE 115-b determined a TB size associated with the one or more first downlink messages (e.g., whether the UE 115-b decoded the first control information message), and one or more second bits used to indicate the feedback for the one or more first downlink messages may indicate whether the one or more first downlink messages were decoded (e.g., were received and decoded or were not received or were not decoded). In some cases, a first bit value for the first bit may indicate that the UE 115-b determine the TB size (e.g., decoded the first control information message) and a second bit value for the first bit may indicate that the UE 115-b did not determine (e.g., missed) the TB size (e.g., did not decode at least a portion of the first control information message). Additionally, a first bit value for a second bit of the one or more second bits may indicate that a respective first downlink message of the one or more first downlink messages was decoded, and a second bit value for the second bit of the one or more second bits may indicate that the respective first downlink message of the multiple first downlink messages was not decoded. In some examples, a CRC associated with the first control information message may be scrambled with a C-RNTI.

In some other cases, the first control information message may be associated with the first type of control information message (e.g., the first special DCI) based on the first control information indicating a state change (e.g., indicating, or triggering, an action for the UE 115-b to perform). The state change may be associated with a TCI state change, a BWP change, an SSS group switch, a downlink control channel monitoring skip (e.g., PDCCH skip), a cell dormancy (e.g., transitioning a cell to or from dormancy), a scheduling offset change, or any combination thereof.

In such cases, both the difference between the first value and the second value and the quantity of bits used to indicate feedback for the multiple first downlink messages may be equal to one more than a third quantity of the one or more first downlink messages based on the first control information message being associated with the first type of control information message (e.g., being a special DCI). For example, a first bit used to indicate the feedback for the one or more first downlink messages may indicate whether the UE 115-b performed the state change (e.g., whether the UE 115-b decoded the first control information message), and one or more second bits used to indicate the feedback for the one or more first downlink messages may indicate whether the one or more first downlink messages were decoded. In some cases, a first bit value for the first bit may indicate that the UE 115-b performed the state change (e.g., decoded the first control information message) and a second bit value for the first bit may indicate that the UE 115-b did not perform the state change (e.g., did not decode at least a portion of the first control information message). Additionally, a first bit value for a second bit of the one or more second bits may indicate that a respective first downlink message of the one or more first downlink messages was decoded, and a second bit value for the second bit of the one or more second bits may indicate that the respective first downlink message of the multiple first downlink messages was not decoded. In some examples, a CRC associated with the first control information message may be scrambled with a C-RNTI.

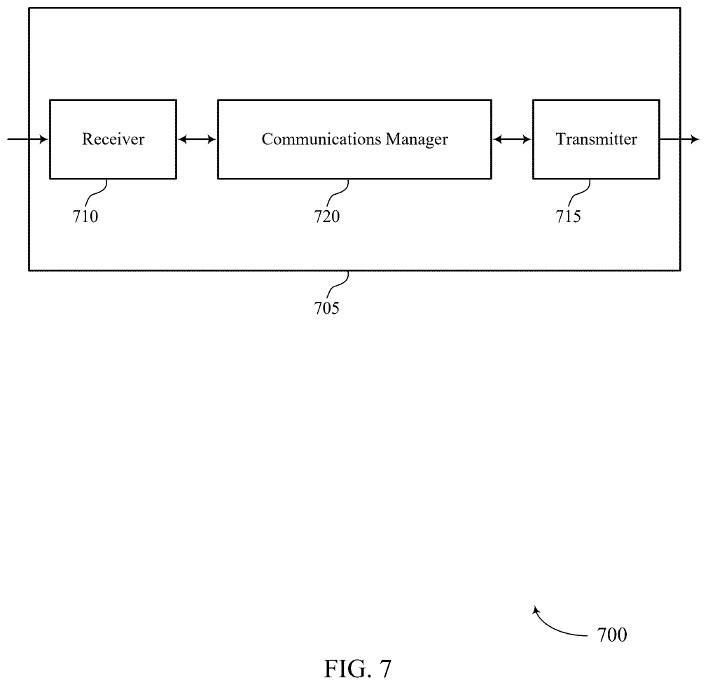

FIG. 7 shows a block diagram 700 of a device 705 that supports techniques for indicating feedback with unequal quantities of bits per DAI in accordance with one or more aspects of the present disclosure. The device 705 may be an example of aspects of a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor (not shown), which may be coupled with at least one memory, to, individually or collectively, support or enable the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to techniques for indicating feedback with unequal quantities of bits per DAI). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to techniques for indicating feedback with unequal quantities of bits per DAI). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations or components thereof may be examples of means for performing various aspects of techniques for indicating feedback with unequal quantities of bits per DAI as described herein. For example, the communications manager 720, the receiver 710, the transmitter 715, or various combinations or components thereof may be capable of performing one or more of the functions described herein.

In some examples, the communications manager 720, the receiver 710, the transmitter 715, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 720, the receiver 710, the transmitter 715, or various combinations or components thereof may be implemented in code (e.g., as communications management software or firmware) executed by at least one processor (e.g., referred to as a processor-executable code). If implemented in code executed by at least one processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. For example, the communications manager 720 is capable of, configured to, or operable to support a means for monitoring for a set of multiple control information messages that each schedule one or more downlink messages, the set of multiple control information messages including at least a first control information message, where a first value of a counter field of the first control information message is incremented from a second value of the counter field of a previous control information message of the set of multiple control information messages, and where a difference between the first value and the second value is based on whether the first control information message is associated with a first type of control information message or a second type of control information message. The communications manager 720 is capable of, configured to, or operable to support a means for transmitting a feedback message indicating feedback associated with the plurality of control information messages, where a quantity of bits used to indicate the feedback associated with the first control information message is based on whether the first control information message is associated with the first type of control information message or the second type of control information message.

By including or configuring the communications manager 720 in accordance with examples as described herein, the device 705 (e.g., at least one processor controlling or otherwise coupled with the receiver 710, the transmitter 715, the communications manager 720, or a combination thereof) may support techniques for indicating feedback with unequal quantities of bits per DIA, which may result in reduced processing, reduced power consumption, and more efficient utilization of communication resources, among other advantages.

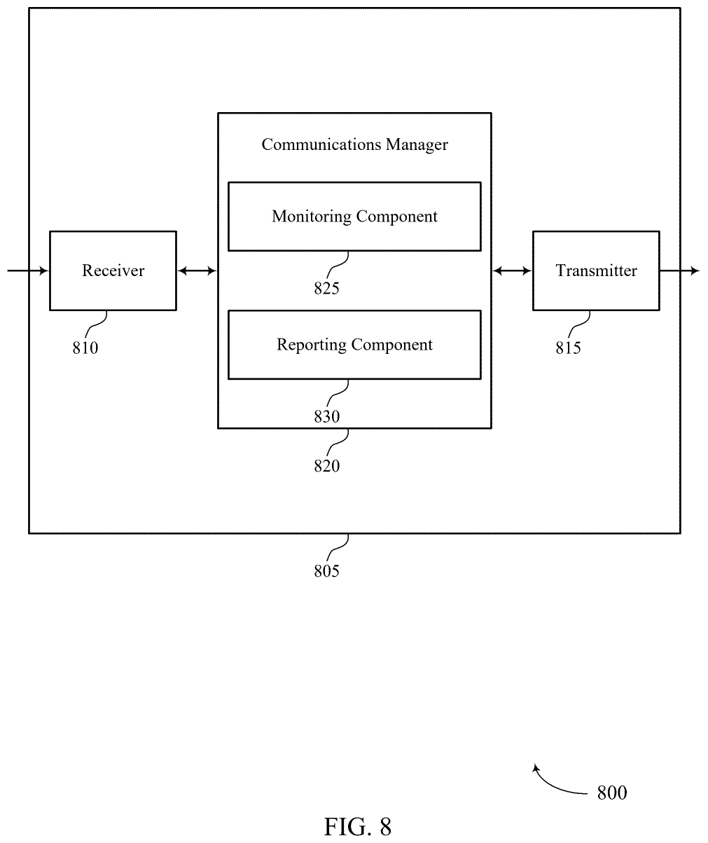

FIG. 8 shows a block diagram 800 of a device 805 that supports techniques for indicating feedback with unequal quantities of bits per DAI in accordance with one or more aspects of the present disclosure. The device 805 may be an example of aspects of a device 705 or a UE 115 as described herein. The device 805 may include a receiver 810, a transmitter 815, and a communications manager 820. The device 805, or one or more components of the device 805 (e.g., the receiver 810, the transmitter 815, the communications manager 820), may include at least one processor (not shown), which may be coupled with at least one memory, to support the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to techniques for indicating feedback with unequal quantities of bits per DAI). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to techniques for indicating feedback with unequal quantities of bits per DAI). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of techniques for indicating feedback with unequal quantities of bits per DAI as described herein. For example, the communications manager 820 may include a monitoring component 825 a reporting component 830, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. The monitoring component 825 is capable of, configured to, or operable to support a means for monitoring for a set of multiple control information messages that each schedule one or more downlink messages, the set of multiple control information messages including at least a first control information message, where a first value of a counter field of the first control information message is incremented from a second value of the counter field of a previous control information message of the set of multiple control information messages, and where a difference between the first value and the second value is based on whether the first control information message is associated with a first type of control information message or a second type of control information message. The reporting component 830 is capable of, configured to, or operable to support a means for transmitting a feedback message indicating feedback associated with the plurality of control information messages, where a quantity of bits used to indicate the feedback associated with the first control information message is based on whether the first control information message is associated with the first type of control information message or the second type of control information message.

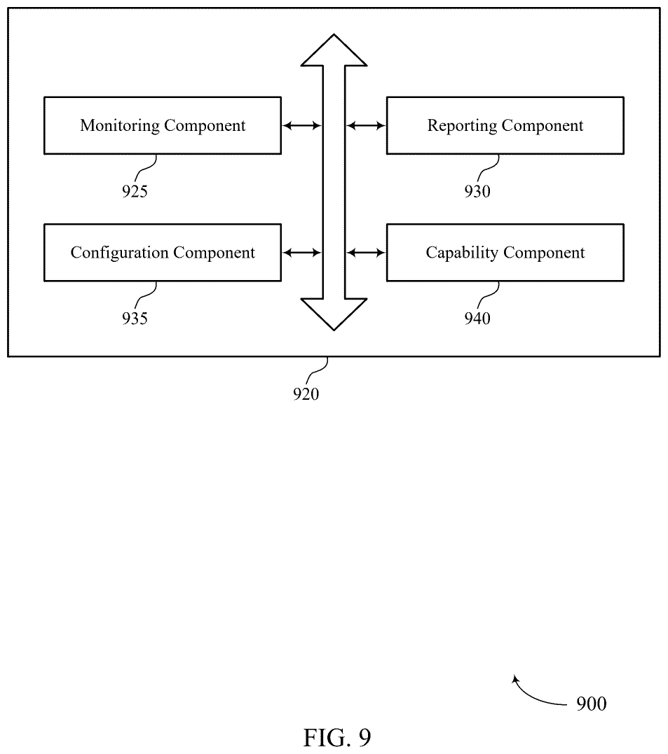

FIG. 9 shows a block diagram 900 of a communications manager 920 that supports techniques for indicating feedback with unequal quantities of bits per DAI in accordance with one or more aspects of the present disclosure. The communications manager 920 may be an example of aspects of a communications manager 720, a communications manager 820, or both, as described herein. The communications manager 920, or various components thereof, may be an example of means for performing various aspects of techniques for indicating feedback with unequal quantities of bits per DAI as described herein. For example, the communications manager 920 may include a monitoring component 925, a reporting component 930, a configuration component 935, a capability component 940, or any combination thereof. Each of these components, or components or subcomponents thereof (e.g., one or more processors, one or more memories), may communicate, directly or indirectly, with one another (e.g., via one or more buses).

The communications manager 920 may support wireless communications in accordance with examples as disclosed herein. The monitoring component 925 is capable of, configured to, or operable to support a means for monitoring for a set of multiple control information messages that each schedule one or more downlink messages, the set of multiple control information messages including at least a first control information message, where a first value of a counter field of the first control information message is incremented from a second value of the counter field of a previous control information message of the set of multiple control information messages, and where a difference between the first value and the second value is based on whether the first control information message is associated with a first type of control information message or a second type of control information message. The reporting component 930 is capable of, configured to, or operable to support a means for transmitting a feedback message indicating feedback associated with the plurality of control information messages, where a quantity of bits used to indicate the feedback associated with the first control information message is based on whether the first control information message is associated with the first type of control information message or the second type of control information message.

In some examples, the first type of control information message is associated with the quantity of bits being associated with a first value. In some examples, the second type of control information message is associated with the quantity of bits being associated with a second value different than the first value.

In some examples, the first value is greater than one. In some examples, the second value is one. In some examples, both the first value and the second value are greater than one. In some examples, the difference between the first value and the second value is greater than one based on the first control information message being associated with the first type of control information message. In some examples, the difference between the first value and the second value is one based on the first control information message being associated with the second type of control information message.

In some examples, the difference between the first value and the second value is a third value greater than one based on the first control information message being associated with the first type of control information message. In some examples, the difference between the first value and the second value is a fourth value greater than one based on the first control information message being associated with the second type of control information message. In some examples, the third value and the fourth value are different.

In some examples, the configuration component 935 is capable of, configured to, or operable to support a means for receiving a configuration message indicating a configuration associated with a set of multiple types of control information messages, including at least the first type of control information message and the second type of control information message.

In some examples, the configuration message is a RRC message. In some examples, the configuration message includes a list of the set of multiple types of control information messages. In some examples, the set of multiple types of control information messages are configured per cell-group, per CC, or both.

In some examples, the capability component 940 is capable of, configured to, or operable to support a means for transmitting a capability message indicating a capability to support a set of multiple types of control information messages including at least the first type of control information message and the second type of control information message, where monitoring for the set of multiple control information messages is based on the capability.

In some examples, the first control information message is associated with the first type of control information message based on the first control information message scheduling a set of multiple first downlink messages. In some examples, both the difference between the first value and the second value and the quantity of bits used to indicate the feedback for the set of multiple first downlink messages are equal to a quantity of the set of multiple first downlink messages based on the first control information message being associated with the first type of control information message.

In some examples, a first bit value for a bit of the quantity of bits indicates that a respective first downlink message of the set of multiple first downlink messages was decoded. In some examples, a second bit value for the bit of the quantity of bits indicates that the respective first downlink message of the set of multiple first downlink messages was not decoded.

In some examples, the first control information message is associated with the first type of control information message based on the first control information message indicating a reserved MCS. In some examples, the first control information message may schedule a first downlink message, In some examples, both the difference between the first value and the second value and the quantity of bits used to indicate the feedback associated with the first control information message are equal to 2 based on the first control information message being associated with the first type of control information message and scheduling the first downlink message.

In some examples, the quantity of bits (e.g., two bits) used to indicate the feedback associated with the first control information message jointly indicate whether the UE determined a TB size associated with the first downlink message and whether the first downlink message was decoded.

In some examples, a first value of the quantity of bits (e.g., ‘11’) indicates that the UE decoded the first control information message, decoded the first downlink message, and determined the TB size, a second value of the quantity of bits (e.g., ‘10’) indicates that the UE decoded the first control information message, failed to decode the first downlink message, and determined the TB size, and a third value of the quantity of bits (e.g., ‘01’) indicates the UE decoded the first control information message, failed to decode the first downlink message, and failed to determine the TB size. In some examples, a fourth value of the quantity of bits (e.g., ‘00’) indicates the UE failed to decode the first control information message, failed to decode the first downlink message, and failed to determine the TB size. In some examples, a CRC associated with the first control information message is scrambled with a C-RNTI.

In some examples, the first control information message is associated with the first type of control information message based on the first control information message indicating a state change. In some examples, the first control information message schedules a first downlink message. In some examples, both the difference between the first value and the second value and the quantity of bits used to indicate the feedback associated with the first control information message are equal to 2 based on the first control information message being associated with the first type of control information message and scheduling the first downlink message.

In some examples, a first bit used to indicate the feedback associated with the first control information message indicates whether the UE performed the state change. In some examples, a second bit used to indicate the feedback associated with the first control information message indicates whether the first downlink message was decoded. In some examples, a first bit value for the first bit indicates that the state change was performed, and a second bit value for the first bit indicates that the state change was not performed.

In some examples, the state change is associated with a TCI state change, a BWP change, a SSS group switch, a downlink control channel monitoring skip, a cell dormancy, a scheduling offset change, or any combination thereof. In some examples, the first control information message includes a field indicating whether the first control information message is associated with the first type of control information message or the second type of control information message.

In some examples, the first control information message schedules a first downlink message. In some examples, a first value of the field indicates the first control information message is associated with the first type of control information message and a second value of the field indicates the first control information message is associated with the second type of control information message.

In some examples, the first type of control information message is associated with a set of multiple bits being used to indicate the feedback associated with the first control information message. In some examples, a first bit of the set of multiple bits indicates whether the first control information message was decoded. In some examples, a second bit of the set of multiple bits indicates whether the first downlink message was decoded.

In some examples, the first control information message is associated with the first type of control information message based on the first control information message excluding a field indicating whether the first control information message is associated with the first type of control information message or the second type of control information message.

In some examples, the UE is preconfigured with a set of multiple types of control information messages, including at least the first type of control information message and the second type of control information message. In some examples, the set of multiple types of control information messages are configured per cell-group, per CC, or both.

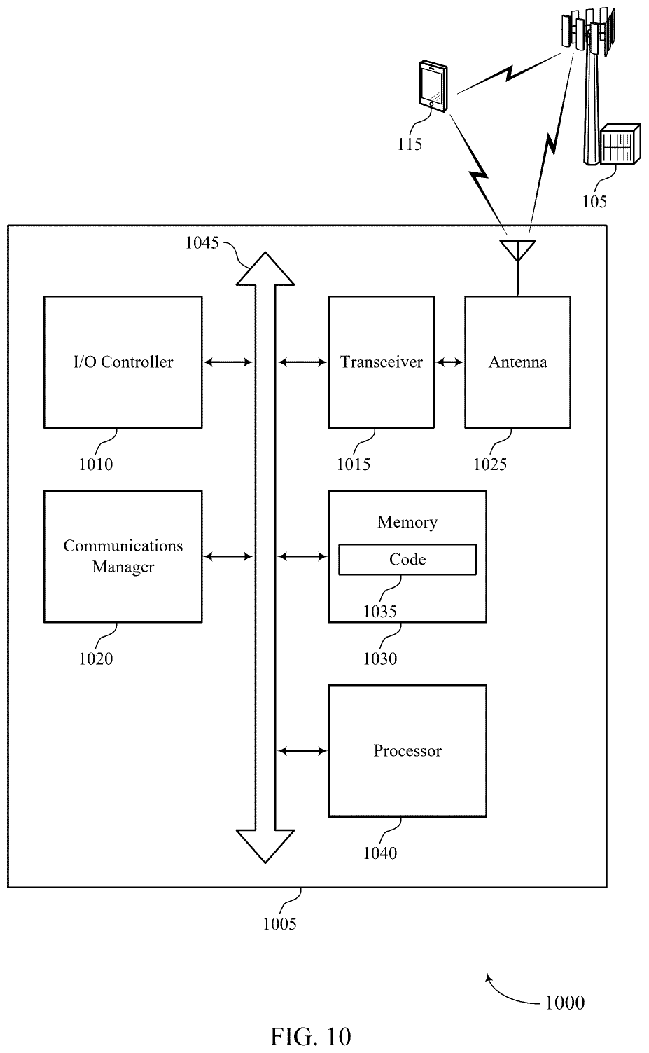

FIG. 10 shows a diagram of a system 1000 including a device 1005 that supports techniques for indicating feedback with unequal quantities of bits per DAI in accordance with one or more aspects of the present disclosure. The device 1005 may be an example of or include components of a device 705, a device 805, or a UE 115 as described herein. The device 1005 may communicate (e.g., wirelessly) with one or more other devices (e.g., network entities 105, UEs 115, or a combination thereof). The device 1005 may include components for bi-directional voice and data communications including components for transmitting and receiving communications, such as a communications manager 1020, an input/output (I/O) controller, such as an I/O controller 1010, a transceiver 1015, one or more antennas 1025, at least one memory 1030, code 1035, and at least one processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of one or more processors, such as the at least one processor 1040. In some cases, a user may interact with the device 1005 via the I/O controller 1010 or via hardware components controlled by the I/O controller 1010.

In some cases, the device 1005 may include a single antenna (such as antenna 1025). However, in some other cases, the device 1005 may have more than one antenna (such as multiple antenna 1025), which may be capable of concurrently transmitting or receiving multiple wireless transmissions. The transceiver 1015 may communicate bi-directionally via the one or more antennas 1025 using wired or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The at least one memory 1030 may include random access memory (RAM) and read-only memory (ROM). The at least one memory 1030 may store computer-readable, computer-executable, or processor-executable code, such as the code 1035. The code 1035 may include instructions that, when executed by the at least one processor 1040, cause the device 1005 to perform various functions described herein. The code 1035 may be stored in a non-transitory computer-readable medium such as system memory or another type of memory. In some cases, the code 1035 may not be directly executable by the at least one processor 1040 but may cause a computer (e.g., when compiled and executed) to perform functions described herein. In some cases, the at least one memory 1030 may include, among other things, a basic I/O system (BIOS) which may control basic hardware or software operation such as the interaction with peripheral components or devices.

The at least one processor 1040 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1040 may be configured to operate a memory array using a memory controller. In some other cases, a memory controller may be integrated into the at least one processor 1040. The at least one processor 1040 may be configured to execute computer-readable instructions stored in a memory (e.g., the at least one memory 1030) to cause the device 1005 to perform various functions (e.g., functions or tasks supporting techniques for indicating feedback with unequal quantities of bits per DAI). For example, the device 1005 or a component of the device 1005 may include at least one processor 1040 and at least one memory 1030 coupled with or to the at least one processor 1040, the at least one processor 1040 and the at least one memory 1030 configured to perform various functions described herein.

In some examples, the at least one processor 1040 may include multiple processors and the at least one memory 1030 may include multiple memories. One or more of the multiple processors may be coupled with one or more of the multiple memories, which may, individually or collectively, be configured to perform various functions described herein. In some examples, the at least one processor 1040 may be a component of a processing system, which may refer to a system (such as a series) of machines, circuitry (including, for example, one or both of processor circuitry (which may include the at least one processor 1040) and memory circuitry (which may include the at least one memory 1030)), or components, that receives or obtains inputs and processes the inputs to produce, generate, or obtain a set of outputs. The processing system may be configured to perform one or more of the functions described herein. For example, the at least one processor 1040 or a processing system including the at least one processor 1040 may be configured to, configurable to, or operable to cause the device 1005 to perform one or more of the functions described herein. Further, as described herein, being “configured to,” being “configurable to,” and being “operable to” may be used interchangeably and may be associated with a capability, when executing code 1035 (e.g., processor-executable code) stored in the at least one memory 1030 or otherwise, to perform one or more of the functions described herein.

The communications manager 1020 may support wireless communications in accordance with examples as disclosed herein. For example, the communications manager 1020 is capable of, configured to, or operable to support a means for monitoring for a set of multiple control information messages that each schedule one or more downlink messages, the set of multiple control information messages including at least a first control information message, where a first value of a counter field of the first control information message is incremented from a second value of the counter field of a previous control information message of the set of multiple control information messages, and where a difference between the first value and the second value is based on whether the first control information message is associated with a first type of control information message or a second type of control information message. The communications manager 1020 is capable of, configured to, or operable to support a means for transmitting a feedback message indicating feedback associated with the plurality of control information messages, where a quantity of bits used to indicate the feedback associated with the first control information message is based on whether the first control information message is associated with the first type of control information message or the second type of control information message.

By including or configuring the communications manager 1020 in accordance with examples as described herein, the device 1005 may support techniques for indicating feedback with unequal quantities of bits per DIA, which may result in improved communication reliability, reduced latency, improved user experience related to reduced processing, reduced power consumption, more efficient utilization of communication resources, improved coordination between devices, longer battery life, and improved utilization of processing capability, among other advantages.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the at least one processor 1040, the at least one memory 1030, the code 1035, or any combination thereof. For example, the code 1035 may include instructions executable by the at least one processor 1040 to cause the device 1005 to perform various aspects of techniques for indicating feedback with unequal quantities of bits per DAI as described herein, or the at least one processor 1040 and the at least one memory 1030 may be otherwise configured to, individually or collectively, perform or support such operations.

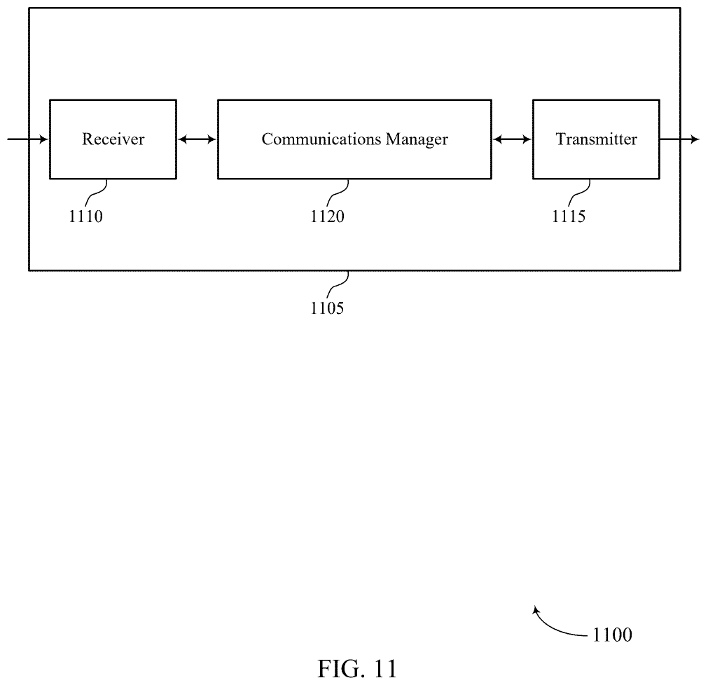

FIG. 11 shows a block diagram 1100 of a device 1105 that supports techniques for indicating feedback with unequal quantities of bits per DAI in accordance with one or more aspects of the present disclosure. The device 1105 may be an example of aspects of a network entity 105 as described herein. The device 1105 may include a receiver 1110, a transmitter 1115, and a communications manager 1120. The device 1105, or one or more components of the device 1105 (e.g., the receiver 1110, the transmitter 1115, the communications manager 1120), may include at least one processor, which may be coupled with at least one memory, to, individually or collectively, support or enable the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations or components thereof may be examples of means for performing various aspects of techniques for indicating feedback with unequal quantities of bits per DAI as described herein. For example, the communications manager 1120, the receiver 1110, the transmitter 1115, or various combinations or components thereof may be capable of performing one or more of the functions described herein.

In some examples, the communications manager 1120, the receiver 1110, the transmitter 1115, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1120, the receiver 1110, the transmitter 1115, or various combinations or components thereof may be implemented in code (e.g., as communications management software or firmware) executed by at least one processor (e.g., referred to as a processor-executable code). If implemented in code executed by at least one processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. For example, the communications manager 1120 is capable of, configured to, or operable to support a means for transmitting a set of multiple control information messages that each schedule one or more downlink messages, the set of multiple control information messages including at least a first control information message, where a first value of a counter field of the first control information message is incremented from a second value of the counter field of a previous control information message of the set of multiple control information messages, and where a difference between the first value and the second value is based on whether the first control information message is associated with a first type of control information message or a second type of control information message. The communications manager 1120 is capable of, configured to, or operable to support a means for receiving a feedback message indicating feedback associated with the plurality of control information messages, where a quantity of bits used to indicate the feedback associated with the first control information message is based on whether the first control information message is associated with the first type of control information message or the second type of control information message.

By including or configuring the communications manager 1120 in accordance with examples as described herein, the device 1105 (e.g., at least one processor controlling or otherwise coupled with the receiver 1110, the transmitter 1115, the communications manager 1120, or a combination thereof) may support techniques for indicating feedback with unequal quantities of bits per DIA, which may result in reduced processing, reduced power consumption, and more efficient utilization of communication resources, among other advantages.

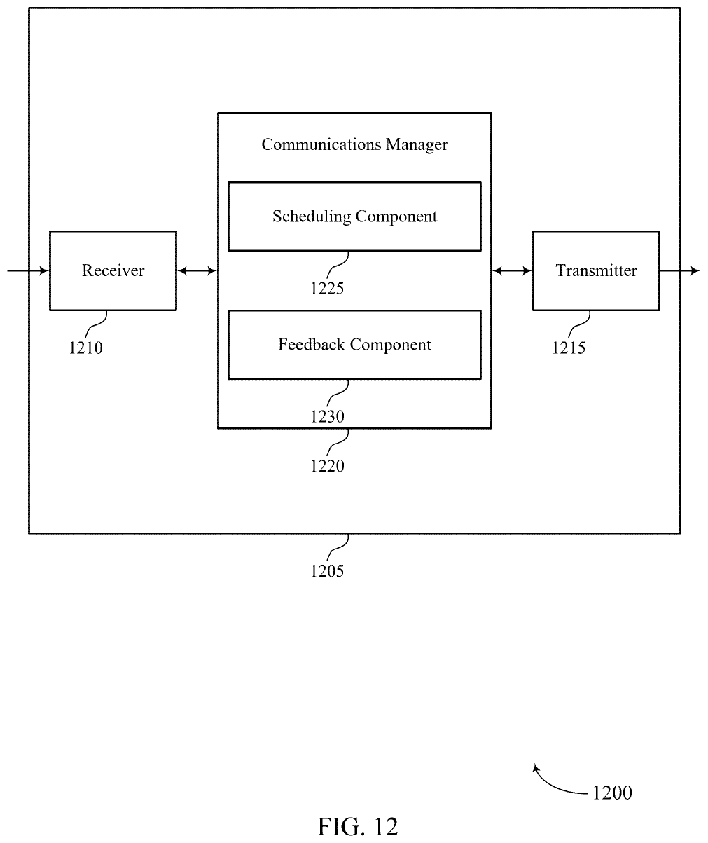

FIG. 12 shows a block diagram 1200 of a device 1205 that supports techniques for indicating feedback with unequal quantities of bits per DAI in accordance with one or more aspects of the present disclosure. The device 1205 may be an example of aspects of a device 1105 or a network entity 105 as described herein. The device 1205 may include a receiver 1210, a transmitter 1215, and a communications manager 1220. The device 1205, or one or more components of the device 1205 (e.g., the receiver 1210, the transmitter 1215, the communications manager 1220), may include at least one processor, which may be coupled with at least one memory, to support the described techniques. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of techniques for indicating feedback with unequal quantities of bits per DAI as described herein. For example, the communications manager 1220 may include a scheduling component 1225 a feedback component 1230, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications in accordance with examples as disclosed herein. The scheduling component 1225 is capable of, configured to, or operable to support a means for transmitting a set of multiple control information messages that each schedule one or more downlink messages, the set of multiple control information messages including at least a first control information message, where a first value of a counter field of the first control information message is incremented from a second value of the counter field of a previous control information message of the set of multiple control information messages, and where a difference between the first value and the second value is based on whether the first control information message is associated with a first type of control information message or a second type of control information message. The feedback component 1230 is capable of, configured to, or operable to support a means for receiving a feedback message indicating feedback associated with the plurality of control information messages, where a quantity of bits used to indicate the feedback associated with the first control information message is based on whether the first control information message is associated with the first type of control information message or the second type of control information message.

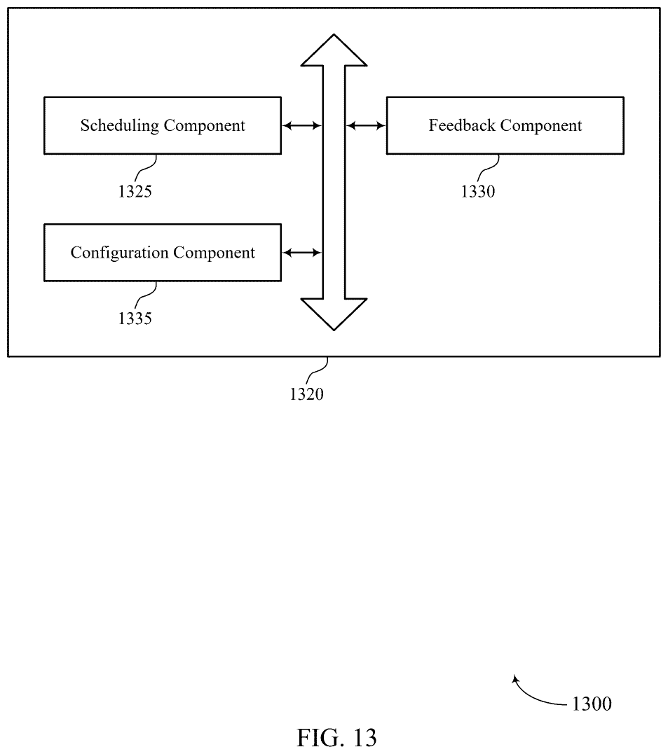

FIG. 13 shows a block diagram 1300 of a communications manager 1320 that supports techniques for indicating feedback with unequal quantities of bits per DAI in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of techniques for indicating feedback with unequal quantities of bits per DAI as described herein. For example, the communications manager 1320 may include a scheduling component 1325, a feedback component 1330, a configuration component 1335, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1320 may support wireless communications in accordance with examples as disclosed herein. The scheduling component 1325 is capable of, configured to, or operable to support a means for transmitting a set of multiple control information messages that each schedule one or more downlink messages, the set of multiple control information messages including at least a first control information message, where a first value of a counter field of the first control information message is incremented from a second value of the counter field of a previous control information message of the set of multiple control information messages, and where a difference between the first value and the second value is based on whether the first control information message is associated with a first type of control information message or a second type of control information message. The feedback component 1330 is capable of, configured to, or operable to support a means for receiving a feedback message indicating feedback associated with the plurality of control information messages, where a quantity of bits used to indicate the feedback associated with the first control information message is based on whether the first control information message is associated with the first type of control information message or the second type of control information message.

In some examples, the first type of control information message is associated with both the difference between the first value and the second value and the quantity of bits being associated with a first value. In some examples, the second type of control information message is associated with both the difference between the first value and the second value and the quantity of bits being associated with a second value different than the first value.

In some examples, the difference between the first value and the second value is greater than one based on the first control information message being associated with the first type of control information message. In some examples, the difference between the first value and the second value is one based on the first control information message being associated with the second type of control information message.

In some examples, the difference between the first value and the second value is a third value greater than one based on the first control information message being associated with the first type of control information message. In some examples, the difference between the first value and the second value is a fourth value greater than one based on the first control information message being associated with the second type of control information message. In some examples, the third value and the fourth value are different.

In some examples, the first value is greater than one. In some examples, the second value is one.

In some examples, both the first value and the second value are greater than one.

In some examples, the configuration component 1335 is capable of, configured to, or operable to support a means for transmitting a configuration message indicating a configuration associated with a set of multiple types of control information messages, including at least the first type of control information message and the second type of control information message.

In some examples, the configuration message is a RRC message.

In some examples, the configuration message includes a list of the set of multiple types of control information messages.

In some examples, the set of multiple types of control information messages are configured per cell-group, per CC, or both.

In some examples, the feedback component 1330 is capable of, configured to, or operable to support a means for receiving a capability message indicating a capability of a UE to support a set of multiple types of control information messages, including at least the first type of control information message and the second type of control information message, where transmitting the set of multiple control information messages is based on the capability of the UE.

In some examples, the first control information message is associated with the first type of control information message based on the first control information message scheduling a set of multiple first downlink messages. In some examples, both the difference between the first value and the second value and the quantity of bits used to indicate the feedback for the set of multiple first downlink messages are equal to a quantity of the set of multiple first downlink messages based on the first control information message being associated with the first type of control information message.

In some examples, a first bit value for a bit of the quantity of bits indicates that a respective first downlink message of the set of multiple first downlink messages was decoded. In some examples, a second bit value for the bit of the quantity of bits indicates the respective first downlink message of the set of multiple first downlink messages was not decoded.

In some examples, the first control information message is associated with the first type of control information message based on the first control information message indicating a reserved MCS. In some examples, the first control information message schedules a first downlink message. In some examples, both the difference between the first value and the second value and the quantity of bits used to indicate the feedback associated with the first control information message are equal to 2 based on the first control information message being associated with the first type of control information message and scheduling the first downlink message.

In some examples, the quantity of bits (e.g., the two bits) used to indicate the feedback associated with the first control information message jointly indicate whether a UE determined a TB size associated with the first downlink message and whether the first downlink message was decoded.

In some examples, a first value of the quantity of bits indicates that the UE decoded the first control information message, decoded the first downlink message, and determined the TB size, a second value of the quantity of bits indicates that the UE decoded the first control information message, failed to decode the first downlink message, and determined the TB size, and a third value of the quantity of bits indicates the UE decoded the first control information message, failed to decode the first downlink message, and failed to determine the TB size. In some examples, a fourth value of the quantity of bits indicates the UE failed to decode the first control information message, failed to decode the first downlink message, and failed to determine the TB size.

In some examples, a CRC associated with the first control information message is scrambled with a C-RNTI.

In some examples, the first control information message is associated with the first type of control information message based on the first control information message indicating a state change. In some examples, the first control information message schedules a first downlink message. In some examples, both the difference between the first value and the second value and the quantity of bits used to indicate the feedback associated with the first control information message are equal to two based on the first control information message being associated with the first type of control information message and scheduling the first downlink message.

In some examples, a first bit used to indicate the feedback associated with the first control information message indicates whether the state change was performed. In some examples, a second bit used to indicate the feedback associated with the first control information message indicate whether the first first downlink message was decoded.

In some examples, a first bit value for the first bit indicates that the state change was performed, and a second bit value for the first bit indicates that the state change was not performed.

In some examples, the state change is associated with a TCI state change, a BWP change, a SSS group switch, a downlink control channel monitoring skip, a cell dormancy, a scheduling offset change, or any combination thereof.

In some examples, the first control information message schedules a first downlink message. In some cases, the first control information message includes a field indicating whether the first control information message is associated with the first type of control information message or the second type of control information message.

In some examples, a first value of the field indicates the first control information message is associated with the first type of control information message and a second value of the field indicates the first control information message is associated with the second type of control information message.

In some examples, the first type of control information message is associated with a set of multiple bits being used to indicate the feedback associated with the first control information message. In some examples, a first bit of the set of multiple bits indicates whether the first control information message was decoded. In some examples, a second bit of the set of multiple bits indicates whether the first downlink message was decoded.

In some examples, the first control information message is associated with the first type of control information message based on the first control information message excluding a field indicating whether the first control information message is associated with the first type of control information message or the second type of control information message.

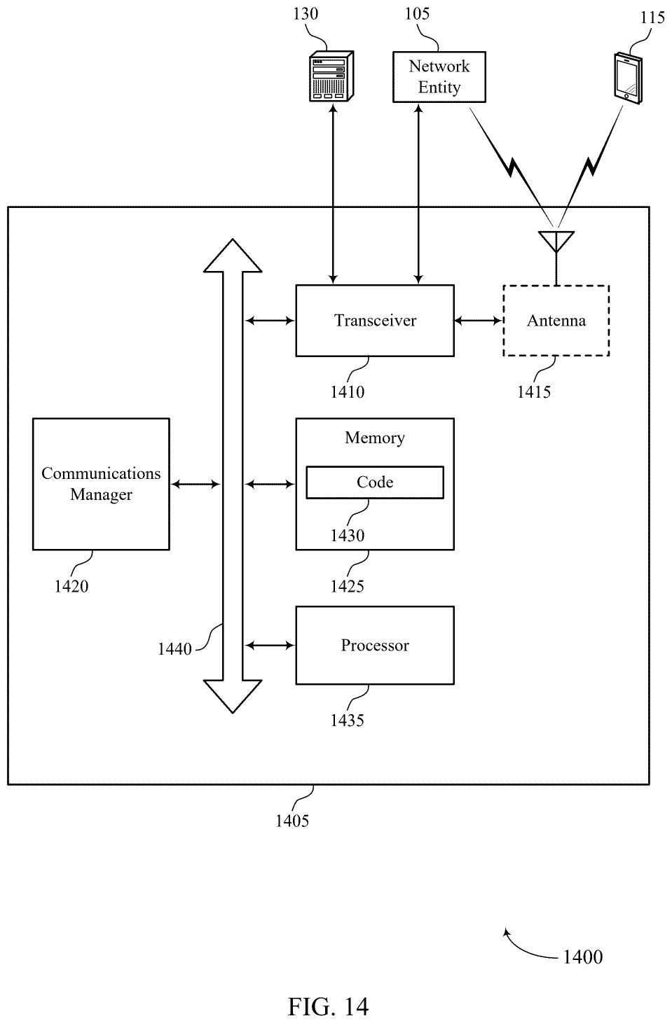

FIG. 14 shows a diagram of a system 1400 including a device 1405 that supports techniques for indicating feedback with unequal quantities of bits per DAI in accordance with one or more aspects of the present disclosure. The device 1405 may be an example of or include components of a device 1105, a device 1205, or a network entity 105 as described herein. The device 1405 may communicate with other network devices or network equipment such as one or more of the network entities 105, UEs 115, or any combination thereof. The communications may include communications over one or more wired interfaces, over one or more wireless interfaces, or any combination thereof. The device 1405 may include components that support outputting and obtaining communications, such as a communications manager 1420, a transceiver 1410, one or more antennas 1415, at least one memory 1425, code 1430, and at least one processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. In some implementations, the transceiver 1410 may include one or more interfaces, such as one or more interfaces coupled with the one or more antennas 1415 that are configured to support various receiving or obtaining operations, or one or more interfaces coupled with the one or more antennas 1415 that are configured to support various transmitting or outputting operations, or a combination thereof. In some implementations, the transceiver 1410 may include or be configured for coupling with one or more processors or one or more memory components that are operable to perform or support operations based on received or obtained information or signals, or to generate information or other signals for transmission or other outputting, or any combination thereof. In some implementations, the transceiver 1410, or the transceiver 1410 and the one or more antennas 1415, or the transceiver 1410 and the one or more antennas 1415 and one or more processors or one or more memory components (e.g., the at least one processor 1435, the at least one memory 1425, or both), may be included in a chip or chip assembly that is installed in the device 1405. In some examples, the transceiver 1410 may be operable to support communications via one or more communications links (e.g., communication link(s) 125, backhaul communication link(s) 120, a midhaul communication link 162, a fronthaul communication link 168).

The at least one memory 1425 may include RAM, ROM, or any combination thereof. The at least one memory 1425 may store computer-readable, computer-executable, or processor-executable code, such as the code 1430. The code 1430 may include instructions that, when executed by one or more of the at least one processor 1435, cause the device 1405 to perform various functions described herein. The code 1430 may be stored in a non-transitory computer-readable medium such as system memory or another type of memory. In some cases, the code 1430 may not be directly executable by a processor of the at least one processor 1435 but may cause a computer (e.g., when compiled and executed) to perform functions described herein. In some cases, the at least one memory 1425 may include, among other things, a BIOS which may control basic hardware or software operation such as the interaction with peripheral components or devices. In some examples, the at least one processor 1435 may include multiple processors and the at least one memory 1425 may include multiple memories. One or more of the multiple processors may be coupled with one or more of the multiple memories which may, individually or collectively, be configured to perform various functions herein (for example, as part of a processing system).

The at least one processor 1435 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1435 may be configured to operate a memory array using a memory controller. In some other cases, a memory controller may be integrated into one or more of the at least one processor 1435. The at least one processor 1435 may be configured to execute computer-readable instructions stored in a memory (e.g., one or more of the at least one memory 1425) to cause the device 1405 to perform various functions (e.g., functions or tasks supporting techniques for indicating feedback with unequal quantities of bits per DAI). For example, the device 1405 or a component of the device 1405 may include at least one processor 1435 and at least one memory 1425 coupled with one or more of the at least one processor 1435, the at least one processor 1435 and the at least one memory 1425 configured to perform various functions described herein. The at least one processor 1435 may be an example of a cloud-computing platform (e.g., one or more physical nodes and supporting software such as operating systems, virtual machines, or container instances) that may host the functions (e.g., by executing code 1430) to perform the functions of the device 1405. The at least one processor 1435 may be any one or more suitable processors capable of executing scripts or instructions of one or more software programs stored in the device 1405 (such as within one or more of the at least one memory 1425).

In some examples, the at least one processor 1435 may include multiple processors and the at least one memory 1425 may include multiple memories. One or more of the multiple processors may be coupled with one or more of the multiple memories, which may, individually or collectively, be configured to perform various functions herein. In some examples, the at least one processor 1435 may be a component of a processing system, which may refer to a system (such as a series) of machines, circuitry (including, for example, one or both of processor circuitry (which may include the at least one processor 1435) and memory circuitry (which may include the at least one memory 1425)), or components, that receives or obtains inputs and processes the inputs to produce, generate, or obtain a set of outputs. The processing system may be configured to perform one or more of the functions described herein. For example, the at least one processor 1435 or a processing system including the at least one processor 1435 may be configured to, configurable to, or operable to cause the device 1405 to perform one or more of the functions described herein. Further, as described herein, being “configured to,” being “configurable to,” and being “operable to” may be used interchangeably and may be associated with a capability, when executing code stored in the at least one memory 1425 or otherwise, to perform one or more of the functions described herein.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the at least one memory 1425, the code 1430, and the at least one processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with one or more other network entities 105, and may include a controller or scheduler for controlling communications with UEs 115 (e.g., in cooperation with the one or more other network devices). In some examples, the communications manager 1420 may support an X2 interface within an LTE/LTE-A wireless communications network technology to provide communication between network entities 105.

The communications manager 1420 may support wireless communications in accordance with examples as disclosed herein. For example, the communications manager 1420 is capable of, configured to, or operable to support a means for transmitting a set of multiple control information messages that each schedule one or more downlink messages, the set of multiple control information messages including at least a first control information message, where a first value of a counter field of the first control information message is incremented from a second value of the counter field of a previous control information message of the set of multiple control information messages, and where a difference between the first value and the second value is based on whether the first control information message is associated with a first type of control information message or a second type of control information message. The communications manager 1420 is capable of, configured to, or operable to support a means for receiving a feedback message indicating feedback associated with the plurality of control information messages, where a quantity of bits used to indicate the feedback associated with the first control information message is based on whether the first control information message is associated with the first type of control information message or the second type of control information message.

By including or configuring the communications manager 1420 in accordance with examples as described herein, the device 1405 may support techniques for indicating feedback with unequal quantities of bits per DIA, which may result in improved communication reliability, reduced latency, improved user experience related to reduced processing, reduced power consumption, more efficient utilization of communication resources, improved coordination between devices, longer battery life, and improved utilization of processing capability, among other advantages.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the transceiver 1410, one or more of the at least one processor 1435, one or more of the at least one memory 1425, the code 1430, or any combination thereof (for example, by a processing system including at least a portion of the at least one processor 1435, the at least one memory 1425, the code 1430, or any combination thereof). For example, the code 1430 may include instructions executable by one or more of the at least one processor 1435 to cause the device 1405 to perform various aspects of techniques for indicating feedback with unequal quantities of bits per DAI as described herein, or the at least one processor 1435 and the at least one memory 1425 may be otherwise configured to, individually or collectively, perform or support such operations.

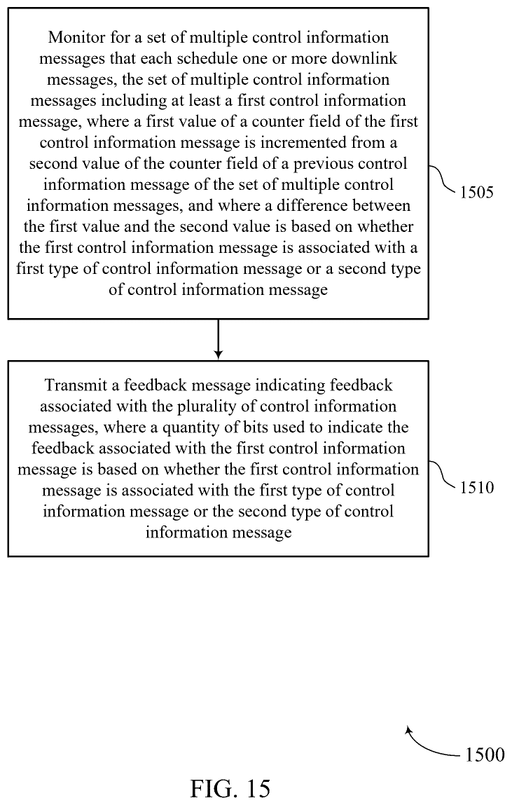

FIG. 15 shows a flowchart illustrating a method 1500 that supports techniques for indicating feedback with unequal quantities of bits per DAI in accordance with one or more aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1505, the method may include monitoring for a set of multiple control information messages that each schedule one or more downlink messages, the set of multiple control information messages including at least a first control information message, where a first value of a counter field of the first control information message is incremented from a second value of the counter field of a previous control information message of the set of multiple control information messages, and where a difference between the first value and the second value is based on whether the first control information message is associated with a first type of control information message or a second type of control information message. The operations of 1505 may be performed in accordance with examples as disclosed herein. In some examples, aspects of the operations of 1505 may be performed by a monitoring component 925 as described with reference to FIG. 9.

At 1510, the method may include transmitting a feedback message indicating feedback associated with the plurality of control information messages, where a quantity of bits used to indicate the feedback associated with the first control information message is based on whether the first control information message is associated with the first type of control information message or the second type of control information message. The operations of 1510 may be performed in accordance with examples as disclosed herein. In some examples, aspects of the operations of 1510 may be performed by a reporting component 930 as described with reference to FIG. 9.

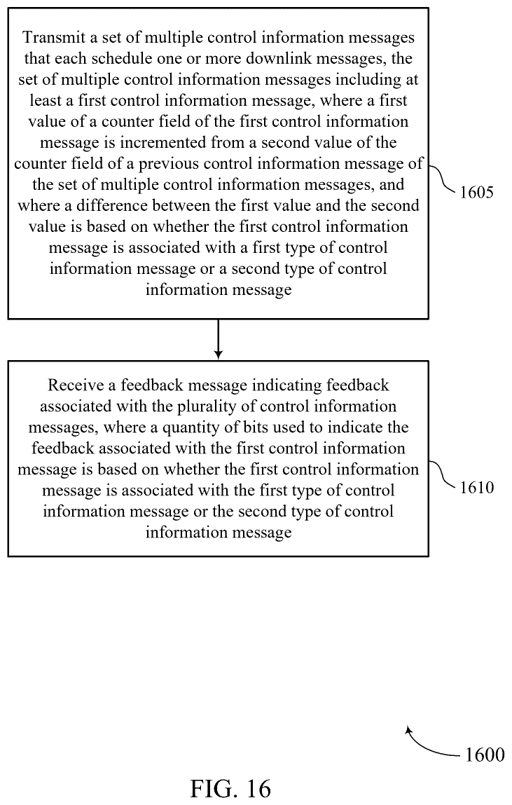

FIG. 16 shows a flowchart illustrating a method 1600 that supports techniques for indicating feedback with unequal quantities of bits per DAI in accordance with one or more aspects of the present disclosure. The operations of the method 1600 may be implemented by a network entity or its components as described herein. For example, the operations of the method 1600 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1605, the method may include transmitting a set of multiple control information messages that each schedule one or more downlink messages, the set of multiple control information messages including at least a first control information message, where a first value of a counter field of the first control information message is incremented from a second value of the counter field of a previous control information message of the set of multiple control information messages, and where a difference between the first value and the second value is based on whether the first control information message is associated with a first type of control information message or a second type of control information message. The operations of 1605 may be performed in accordance with examples as disclosed herein. In some examples, aspects of the operations of 1605 may be performed by a scheduling component 1325 as described with reference to FIG. 13.

At 1610, the method may include receiving a feedback message indicating feedback associated with the plurality of control information messages, where a quantity of bits used to indicate the feedback associated with the first control information message is based on whether the first control information message is associated with the first type of control information message or the second type of control information message. The operations of 1610 may be performed in accordance with examples as disclosed herein. In some examples, aspects of the operations of 1610 may be performed by a feedback component 1330 as described with reference to FIG. 13.

The following provides an overview of aspects of the present disclosure:

Aspect 1: A method for wireless communications at a UE, comprising: monitoring for a plurality of control information messages that each schedule one or more downlink messages, the plurality of control information messages including at least a first control information message, wherein a first value of a counter field of the first control information message is incremented from a second value of the counter field of a previous control information message of the plurality of control information messages, and wherein a difference between the first value and the second value is based at least in part on whether the first control information message is associated with a first type of control information message or a second type of control information message; and transmitting a feedback message indicating feedback associated with the plurality of control information messages, wherein a quantity of bits used to indicate the feedback associated with the first control information message is based at least in part on whether the first control information message is associated with the first type of control information message or the second type of control information message.

Aspect 2: The method of aspect 1, wherein the first type of control information message is associated with the quantity of bits being associated with a first value, and the second type of control information message is associated with the quantity of bits being associated with a second value different than the first value.

Aspect 3: The method of any of aspects 1 through 2, further comprising: receiving a configuration message indicating a configuration associated with a plurality of types of control information messages, including at least the first type of control information message and the second type of control information message.

Aspect 4: The method of any of aspects 1 through 3, further comprising: transmitting a capability message indicating a capability to support a plurality of types of control information messages including at least the first type of control information message and the second type of control information message, wherein monitoring for the plurality of control information messages is based at least in part on the capability.

Aspect 5: The method of any of aspects 1 through 4, wherein the first control information message is associated with the first type of control information message based at least in part on the first control information message scheduling a plurality of first downlink messages, and both the difference between the first value and the second value and the quantity of bits used to indicate the feedback for the plurality of first downlink messages are equal to a quantity of the plurality of first downlink messages based at least in part on the first control information message being associated with the first type of control information message.

Aspect 6: The method of aspect 5, wherein a first bit value for a bit of the quantity of bits indicates that a respective first downlink message of the plurality of first downlink messages was decoded, and a second bit value for the bit of the quantity of bits indicates that the respective first downlink message of the plurality of first downlink messages was not decoded.

Aspect 7: The method of any of aspects 1 through 6, wherein the first control information message is associated with the first type of control information message based at least in part on the first control information message indicating a reserved MCS, the first control information message schedules a first downlink message, and both the difference between the first value and the second value and the quantity of bits used to indicate the feedback associated with the first control information message are equal to two based at least in part on the first control information message being associated with the first type of control information message and scheduling the first downlink message.

Aspect 8: The method of aspect 7, wherein the quantity of bits used to indicate the feedback associated with the first control information message jointly indicates whether the UE determined a TB size associated with the first downlink message and whether the first downlink message was decoded.

Aspect 9: The method of aspect 8, wherein a first value of the quantity of bits indicates that the UE decoded the first control information message, decoded the first downlink message, and determined the TB size, a second value of the quantity of bits indicates that the UE decoded the first control information message, failed to decode the first downlink message, and determined the TB size, and a third value of the quantity of bits indicates the UE decoded the first control information message, failed to decode the first downlink message, and failed to determine the TB size.

Aspect 10: The method of aspect 9, wherein a fourth value of the quantity of bits indicates the UE failed to decode the first control information message, failed to decode the first downlink message, and failed to determine the TB size.

Aspect 11: The method of any of aspects 1 through 10, wherein the first control information message is associated with the first type of control information message based at least in part on the first control information message indicating a state change, the first control information message schedules a first downlink message, and both the difference between the first value and the second value and the quantity of bits used to indicate the feedback associated with the first control information message are equal to 2 based at least in part on the first control information message being associated with the first type of control information message and scheduling the first downlink message.

Aspect 12: The method of aspect 11, wherein a first bit used to indicate the feedback associated with the first control information message indicates whether the UE performed the state change, and a second bit used to indicate the feedback associated with the first control information message indicates whether the first downlink message was decoded.

Aspect 13: The method of aspect 12, wherein a first bit value for the first bit indicates that the state change was performed, and a second bit value for the first bit indicates that the state change was not performed.

Aspect 14: The method of any of aspects 11 through 13, wherein the state change is associated with a TCI state change, a BWP change, an SSS group switch, a downlink control channel monitoring skip, a cell dormancy, a scheduling offset change, or any combination thereof.

Aspect 15: The method of any of aspects 1 through 14, wherein the first control information message schedules a first downlink message, and the first control information message comprises a field indicating whether the first control information message is associated with the first type of control information message or the second type of control information message.

Aspect 16: The method of aspect 15, wherein the first type of control information message is associated with a plurality of bits being used to indicate the feedback associated with the first control information message, a first bit of the plurality of bits indicates whether the first control information message was decoded, and a second bit of the plurality of bits indicates whether the first downlink message was decoded.

Aspect 17: The method of any of aspects 1 through 16, wherein the first control information message is associated with the first type of control information message based at least in part on the first control information message excluding a field indicating whether the first control information message is associated with the first type of control information message or the second type of control information message.

Aspect 18: A method for wireless communications at network entity, comprising: transmitting a plurality of control information messages that each schedule one or more downlink messages, the plurality of control information messages including at least a first control information message, wherein a first value of a counter field of the first control information message is incremented from a second value of the counter field of a previous control information message of the plurality of control information messages, and wherein a difference between the first value and the second value is based at least in part on whether the first control information message is associated with a first type of control information message or a second type of control information message; and receiving a feedback message indicating feedback associated with the plurality of control information messages, wherein a quantity of bits used to indicate the feedback associated with the first control information message is based at least in part on whether the first control information message is associated with the first type of control information message or the second type of control information message.

Aspect 19: The method of aspect 18, wherein the first type of control information message is associated with both the difference between the first value and the second value and the quantity of bits being associated with a first value, and the second type of control information message is associated with both the difference between the first value and the second value and the quantity of bits being associated with a second value different than the first value.

Aspect 20: The method of any of aspects 18 through 19, further comprising: transmitting a configuration message indicating a configuration associated with a plurality of types of control information messages, including at least the first type of control information message and the second type of control information message.

Aspect 21: The method of any of aspects 18 through 20, further comprising: receiving a capability message indicating a capability of a UE to support a plurality of types of control information messages, including at least the first type of control information message and the second type of control information message, wherein transmitting the plurality of control information messages is based at least in part on the capability of the UE.

Aspect 22: The method of any of aspects 18 through 21, wherein the first control information message is associated with the first type of control information message based at least in part on the first control information message scheduling a plurality of first downlink messages, and both the difference between the first value and the second value and the quantity of bits used to indicate the feedback for the plurality of first downlink messages are equal to a quantity of the plurality of first downlink messages based at least in part on the first control information message being associated with the first type of control information message.

Aspect 23: The method of any of aspects 18 through 22, wherein the first control information message is associated with the first type of control information message based at least in part on the first control information message indicating a reserved MCS, the first control information message schedules a first downlink message, and both the difference between the first value and the second value and the quantity of bits used to indicate the feedback associated with the first control information message are equal to two based at least in part on the first control information message being associated with the first type of control information message and scheduling the first downlink message.

Aspect 24: The method of aspect 23, wherein the quantity of bits used to indicate the feedback associated with the first control information message jointly indicate whether a UE determined a TB size associated with the first downlink message and whether the first downlink message was decoded.

Aspect 25: The method of any of aspects 18 through 24, wherein the first control information message is associated with the first type of control information message based at least in part on the first control information message indicating a state change, the first control information message schedules a first downlink message, and both the difference between the first value and the second value and the quantity of bits used to indicate the feedback associated with the first control information message are equal to 2 based at least in part on the first control information message being associated with the first type of control information message and scheduling the first downlink message.

Aspect 26: The method of any of aspects 18 through 25, wherein the first control information message schedules a first downlink message, and the first control information message comprises a field indicating whether the first control information message is associated with the first type of control information message or the second type of control information message.

Aspect 27: The method of aspect 26, wherein the first type of control information message is associated with a plurality of bits being used to indicate the feedback associated with the first control information message, a first bit of the plurality of bits indicates whether the first control information message was decoded, and a second bit of the plurality of bits indicate whether the first downlink message was decoded.

Aspect 28: The method of any of aspects 18 through 27, wherein the first control information message is associated with the first type of control information message based at least in part on the first control information message excluding a field indicating whether the first control information message is associated with the first type of control information message or the second type of control information message.

Aspect 29: A UE for wireless communications, comprising one or more memories storing processor-executable code, and one or more processors coupled with the one or more memories and individually or collectively operable to execute the code to cause the UE to perform a method of any of aspects 1 through 17.

Aspect 30: A UE for wireless communications, comprising at least one means for performing a method of any of aspects 1 through 17.

Aspect 31: A non-transitory computer-readable medium storing code for wireless communications, the code comprising instructions executable by one or more processors to perform a method of any of aspects 1 through 17.

Aspect 32: A network entity for wireless communications, comprising one or more memories storing processor-executable code, and one or more processors coupled with the one or more memories and individually or collectively operable to execute the code to cause the network entity to perform a method of any of aspects 18 through 28.

Aspect 33: A network entity for wireless communications, comprising at least one means for performing a method of any of aspects 18 through 28.

Aspect 34: A non-transitory computer-readable medium storing code for wireless communications, the code comprising instructions executable by one or more processors to perform a method of any of aspects 18 through 28.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
at least one processor; and
at least one memory coupled with the at least one processor, with instructions stored in the at least one memory, the instructions being executable by the at least one processor, individually or in any combination, to cause the UE to:
monitor for a plurality of control information messages that each schedule one or more downlink messages, the plurality of control information messages including at least a first control information message, wherein a first value of a counter field of the first control information message is incremented from a second value of the counter field of a previous control information message of the plurality of control information messages, and wherein a difference between the first value and the second value is based at least in part on whether the first control information message is associated with a first type of control information message or a second type of control information message; and
transmit a feedback message indicating feedback associated with the plurality of control information messages, wherein a quantity of bits used to indicate the feedback associated with the first control information message is based at least in part on whether the first control information message is associated with the first type of control information message or the second type of control information message.

2. The UE of claim 1, wherein the first type of control information message is associated with the quantity of bits being associated with a first value, and wherein the second type of control information message is associated with the quantity of bits being associated with a second value different than the first value.

3. The UE of claim 1, wherein the instructions are executable by the at least one processor, individually or in any combination, to cause the UE to:
receive a configuration message indicating a configuration associated with a plurality of types of control information messages, including at least the first type of control information message and the second type of control information message.

4. The UE of claim 1, wherein the instructions are executable by the at least one processor, individually or in any combination, to cause the UE to:
transmit a capability message indicating a capability to support a plurality of types of control information messages including at least the first type of control information message and the second type of control information message, wherein monitoring for the plurality of control information messages is based at least in part on the capability.

5. The UE of claim 1, wherein the first control information message is associated with the first type of control information message based at least in part on the first control information message scheduling a plurality of first downlink messages, and wherein both the difference between the first value and the second value and the quantity of bits used to indicate the feedback for the plurality of first downlink messages are equal to a quantity of the plurality of first downlink messages based at least in part on the first control information message being associated with the first type of control information message.

6. The UE of claim 5, wherein a first bit value for a bit of the quantity of bits indicates that a respective first downlink message of the plurality of first downlink messages was decoded, and wherein a second bit value for the bit of the quantity of bits indicates that the respective first downlink message of the plurality of first downlink messages was not decoded.

7. The UE of claim 1, wherein the first control information message is associated with the first type of control information message based at least in part on the first control information message indicating a reserved modulation and coding scheme (MCS), wherein the first control information message schedules a first downlink message, and wherein both the difference between the first value and the second value and the quantity of bits used to indicate the feedback associated with the first control information message are equal to two based at least in part on the first control information message being associated with the first type of control information message and scheduling the first downlink message.

8. The UE of claim 7, wherein the quantity of bits used to indicate the feedback associated with the first control information message jointly indicates whether the UE determined a transport block size associated with the first downlink message and whether the first downlink message was decoded.

9. The UE of claim 8, wherein:
a first value of the quantity of bits indicates that the UE decoded the first control information message, decoded the first downlink message, and determined the transport block size,
a second value of the quantity of bits indicates that the UE decoded the first control information message, failed to decode the first downlink message, and determined the transport block size, and
a third value of the quantity of bits indicates the UE decoded the first control information message, failed to decode the first downlink message, and failed to determine the transport block size.

10. The UE of claim 9, wherein a fourth value of the quantity of bits indicates the UE failed to decode the first control information message, failed to decode the first downlink message, and failed to determine the transport block size.

11. The UE of claim 1, wherein the first control information message is associated with the first type of control information message based at least in part on the first control information message indicating a state change, wherein the first control information message schedules a first downlink message, and wherein both the difference between the first value and the second value and the quantity of bits used to indicate the feedback associated with the first control information message are equal to 2 based at least in part on the first control information message being associated with the first type of control information message and scheduling the first downlink message.

12. The UE of claim 11, wherein a first bit used to indicate the feedback associated with the first control information message indicates whether the UE performed the state change, and wherein a second bit used to indicate the feedback associated with the first control information message indicates whether the first downlink message was decoded.

13. The UE of claim 12, wherein a first bit value for the first bit indicates that the state change was performed, and a second bit value for the first bit indicates that the state change was not performed.

14. The UE of claim 11, wherein the state change is associated with a transmission configuration indicator state change, a bandwidth part change, a search space set group switch, a downlink control channel monitoring skip, a cell dormancy, a scheduling offset change, or any combination thereof.

15. The UE of claim 1, wherein the first control information message schedules a first downlink message, and wherein the first control information message comprises a field indicating whether the first control information message is associated with the first type of control information message or the second type of control information message.

16. The UE of claim 15, wherein the first type of control information message is associated with a plurality of bits being used to indicate the feedback associated with the first control information message, wherein a first bit of the plurality of bits indicates whether the first control information message was decoded, and wherein a second bit of the plurality of bits indicates whether the first downlink message was decoded.

17. The UE of claim 1, wherein the first control information message is associated with the first type of control information message based at least in part on the first control information message excluding a field indicating whether the first control information message is associated with the first type of control information message or the second type of control information message.

18. A network entity, comprising:
at least one processor; and
at least one memory coupled with the at least one processor, with instructions stored in the at least one memory, the instructions being executable by the at least one processor, individually or in any combination, to cause the network entity to:
transmit a plurality of control information messages that each schedule one or more downlink messages, the plurality of control information messages including at least a first control information message, wherein a first value of a counter field of the first control information message is incremented from a second value of the counter field of a previous control information message of the plurality of control information messages, and wherein a difference between the first value and the second value is based at least in part on whether the first control information message is associated with a first type of control information message or a second type of control information message; and
receive a feedback message indicating feedback associated with the plurality of control information messages, wherein a quantity of bits used to indicate the feedback associated with the first control information message is based at least in part on whether the first control information message is associated with the first type of control information message or the second type of control information message.

19. The network entity of claim 18, wherein the first type of control information message is associated with both the difference between the first value and the second value and the quantity of bits being associated with a first value, and wherein the second type of control information message is associated with both the difference between the first value and the second value and the quantity of bits being associated with a second value different than the first value.

20. The network entity of claim 18, wherein the instructions are executable by the at least one processor, individually or in any combination, to cause the network entity to:
transmit a configuration message indicating a configuration associated with a plurality of types of control information messages, including at least the first type of control information message and the second type of control information message.

21. The network entity of claim 18, wherein the instructions are executable by the at least one processor, individually or in any combination, to cause the network entity to:
receive a capability message indicating a capability of a user equipment (UE) to support a plurality of types of control information messages, including at least the first type of control information message and the second type of control information message, wherein transmitting the plurality of control information messages is based at least in part on the capability of the UE.

22. The network entity of claim 18, wherein the first control information message is associated with the first type of control information message based at least in part on the first control information message scheduling a plurality of first downlink messages, and wherein both the difference between the first value and the second value and the quantity of bits used to indicate the feedback for the plurality of first downlink messages are equal to a quantity of the plurality of first downlink messages based at least in part on the first control information message being associated with the first type of control information message.

23. The network entity of claim 18, wherein the first control information message is associated with the first type of control information message based at least in part on the first control information message indicating a reserved modulation and coding scheme (MCS), wherein the first control information message schedules a first downlink message, and wherein both the difference between the first value and the second value and the quantity of bits used to indicate the feedback associated with the first control information message are equal to two based at least in part on the first control information message being associated with the first type of control information message and scheduling the first downlink message.

24. The network entity of claim 23, wherein the quantity of bits used to indicate the feedback associated with the first control information message jointly indicate whether a UE determined a transport block size associated with the first downlink message and whether the first downlink message was decoded.

25. The network entity of claim 18, wherein the first control information message is associated with the first type of control information message based at least in part on the first control information message indicating a state change, wherein the first control information message schedules a first downlink message, and wherein both the difference between the first value and the second value and the quantity of bits used to indicate the feedback associated with the first control information message are equal to 2 based at least in part on the first control information message being associated with the first type of control information message and scheduling the first downlink message.

26. The network entity of claim 18, wherein the first control information message schedules a first downlink message, and wherein the first control information message comprises a field indicating whether the first control information message is associated with the first type of control information message or the second type of control information message.

27. The network entity of claim 26, wherein the first type of control information message is associated with a plurality of bits being used to indicate the feedback associated with the first control information message, wherein a first bit of the plurality of bits indicates whether the first control information message was decoded, and wherein a second bit of the plurality of bits indicate whether the first downlink message was decoded.

28. The network entity of claim 18, wherein the first control information message is associated with the first type of control information message based at least in part on the first control information message excluding a field indicating whether the first control information message is associated with the first type of control information message or the second type of control information message.

29. A method for wireless communications at a user equipment (UE), comprising:
monitoring for a plurality of control information messages that each schedule one or more downlink messages, the plurality of control information messages including at least a first control information message, wherein a first value of a counter field of the first control information message is incremented from a second value of the counter field of a previous control information message of the plurality of control information messages, and wherein a difference between the first value and the second value is based at least in part on whether the first control information message is associated with a first type of control information message or a second type of control information message; and
transmitting a feedback message indicating feedback associated with the plurality of control information messages, wherein a quantity of bits used to indicate the feedback associated with the first control information message is based at least in part on whether the first control information message is associated with the first type of control information message or the second type of control information message.

30. A method for wireless communications at a network entity, comprising:
transmitting a plurality of control information messages that each schedule one or more downlink messages, the plurality of control information messages including at least a first control information message, wherein a first value of a counter field of the first control information message is incremented from a second value of the counter field of a previous control information message of the plurality of control information messages, and wherein a difference between the first value and the second value is based at least in part on whether the first control information message is associated with a first type of control information message or a second type of control information message; and
receiving a feedback message indicating feedback associated with the plurality of control information messages, wherein a quantity of bits used to indicate the feedback associated with the first control information message is based at least in part on whether the first control information message is associated with the first type of control information message or the second type of control information message.
